(19) United States
(12) Patent Application Publication
(10) Pub. No.: US 2021/0181491 A1
(43) Pub. Date: Jun. 17, 2021

(54) OPTICAL SYSTEM AND OPTICAL APPARATUS INCLUDING THE SAME

(71) Applicant: OLYMPUS CORPORATION, Tokyo (JP)

(72) Inventor: Takayoshi TOGINO, Tokyo (JP)

(73) Assignee: OLYMPUS CORPORATION, Tokyo (JP)

(21) Appl. No.: 17/189,586

(22) Filed: Mar. 2, 2021

Related U.S. Application Data
(63) Continuation of application No. PCT/JP2019/010087, filed on Mar. 12, 2019.

(51) Int. Cl. G02B 21/02; G02B 13/16; G02B 9/64; G02B 13/18

(52) U.S. Cl. CPC G02B 21/02; G02B 13/18; G02B 9/64; G02B 13/16

(57) ABSTRACT

An optical system is an optical system in which an enlargement-side conjugate point positioned on an enlargement side and a reduction-side conjugate point positioned on a reduction side are conjugate. The optical system includes a super-hemispherical meniscus lens. The super-hemispherical meniscus lens has a reduction-side surface positioned on the reduction side and an enlargement-side surface positioned on the enlargement side. The reduction-side surface is a concave curved surface on the reduction side, and the enlargement-side surface is a convex curved surface on the enlargement side, having a positive refractive power. The curved surface of the enlargement-side surface is a curved surface extending beyond a hemisphere. An intersection of the reduction-side surface and an optical axis of the optical system is positioned closer to the enlargement side than the reduction-side conjugate point is. A reduction-side intersection is positioned closer to the reduction side than the reduction-side conjugate point.

### CROSS-REFERENCE TO RELATED APPLICATION

The present application is a continuation application of International Application No. PCT/JP2019/010087 filed on Mar. 12, 2019, the entire contents of which are incorporated herein by reference.

### BACKGROUND

### Technical Field

The present disclosure relates to an optical system and an optical apparatus including the same.

### Description of the Related Art

The numerical aperture is used as an indicator representing the brightness of an optical system and the resolving power of an optical system. The larger the value of numerical aperture is, the higher the brightness is and the higher the resolving power is. Furthermore, the F-number is also used as an indicator representing the brightness of an optical system and the resolving power of an optical system. The smaller the value of F-number is, the higher the brightness is and the higher the resolving power is.

Japanese Patent Application Laid-open No. 2012-48774 discloses an objective lens having a numerical aperture greater than 1. This objective lens includes a solid immersion lens having a super-hemispherical shape or a hemispherical shape.

Japanese Patent Application Laid-open No. 2017-207772 discloses an immersion objective lens having a numerical aperture of 1.3. Japanese Patent Application Laid-open No. 2018-66913 discloses a microscope immersion objective having a numerical aperture of 1.5.

For example, when an object is a luminous body, light coming toward the optical system and light going away from the optical system are emerged from the object. The brightness and the resolving power of the optical system are determined by the amount of light incident on the optical system. As light that can be incident on the optical system increases, the brightness of the optical system becomes high and the resolving power becomes high.

### SUMMARY

An optical system according to at least some embodiments of the present disclosure is an optical system in which

an enlargement-side conjugate point positioned on an enlargement side and a reduction-side conjugate point positioned on a reduction side are conjugate,

a distance from the optical system to the enlargement-side conjugate point being longer than a distance from the optical system to the reduction-side conjugate point,

the optical system including a super-hemispherical meniscus lens, wherein

the super-hemispherical meniscus lens has a reduction-side surface positioned on the reduction side and an enlargement-side surface positioned on the enlargement side,

the reduction-side surface is a concave curved surface on the reduction side,

the enlargement-side surface is a convex curved surface on the enlargement side, having a positive refractive power,

the curved surface of the enlargement-side surface is a curved surface extending beyond a hemisphere,

an intersection of the reduction-side surface and an optical axis of the optical system is positioned closer to the enlargement side than the reduction-side conjugate point, and

a reduction-side intersection is positioned closer to the reduction side than the reduction-side conjugate point,

where

the reduction-side intersection is an intersection of a reduction-side virtual plane and the optical axis of the optical system,

the reduction-side virtual plane is a plane including an intersection of an outside ray and the reduction-side surface and being orthogonal to the optical axis of the optical system, and

the outside ray is a light ray passing through a position farthest from a center of the reduction-side surface, among light rays contributing to image formation.

An optical apparatus according to at least some embodiments of the present disclosure includes:

the optical system described above and

an image pickup apparatus disposed at the reduction-side conjugate point.

Another optical apparatus according to at least some embodiments of the present disclosure includes:

the optical system described above and

a light source disposed at the reduction-side conjugate point.

Another optical apparatus according to at least some embodiments of the present disclosure includes:

the optical system described above and

a holding mechanism configured to position an object at the reduction-side conjugate point.

Another optical apparatus according to at least some embodiments of the present disclosure includes:

the optical system described above and a display device disposed at the enlargement-side conjugate point.

### BRIEF DESCRIPTION OF THE DRAWINGS

FIG. 1 is a diagram illustrating a first example of an optical system of the present embodiment;

FIG. 2 is a diagram illustrating a second example of the optical system of the present embodiment;

FIG. 3 is a diagram illustrating an outside ray in the optical system of the first example;

FIG. 4 is a diagram illustrating an outside ray in the optical system of the second example;

FIG. 5 is a lens sectional view of an optical system of Example 1;

FIG. 6 is a lens sectional view of an optical system of Example 2;

FIG. 7 is a partial sectional view of the optical system of Example 2;

FIG. 8 is a lens sectional view of an optical system of Example 3;

FIG. 9 is a partial sectional view of the optical system of Example 3;

FIG. 10 is a lens sectional view of an optical system of Example 4;

FIG. 11 is a partial sectional view of the optical system of Example 4;

FIG. 12 is a lens sectional view of an optical system of Example 5;

FIG. 13 is a partial sectional view of the optical system of Example 5;

FIG. 14 is a lens sectional view of an optical system of Example 6;

FIG. 15 is an aberration diagram of the optical system of Example 1;

FIG. 16 is an aberration diagram of the optical system of Example 3;

FIG. 17 is an aberration diagram of the optical system of Example 4;

FIG. 18 is an aberration diagram of the optical system of Example 5;

FIG. 19A and FIG. 19B are diagrams illustrating a first example of an optical apparatus of the present embodiment;

FIG. 20A and FIG. 20B are diagrams illustrating a second example of the optical apparatus of the present embodiment;

FIG. 21A and FIG. 21B are diagrams illustrating a third example of the optical apparatus of the present embodiment;

FIG. 22A and FIG. 22B are diagrams illustrating a holding member; and

FIG. 23 is a diagram illustrating a fourth example of the optical apparatus of the present embodiment.

### DETAILED DESCRIPTION

Prior to the explanation of examples, action and effect of embodiments according to certain aspects of the present disclosure will be described below. In the explanation of the action and effect of the embodiments concretely, the explanation will be made by citing concrete examples. However, similar to a case of the examples to be described later, aspects exemplified thereof are only some of the aspects included in the present disclosure, and there exists a large number of variations in these aspects. Consequently, the present disclosure is not restricted to the aspects that will be exemplified.

An optical system of the present embodiment is an optical system in which an enlargement-side conjugate point positioned on an enlargement side and a reduction-side conjugate point positioned on a reduction side are conjugate. A distance from the optical system to the enlargement-side conjugate point is longer than a distance from the optical system to the reduction-side conjugate point. The optical system includes a super-hemispherical meniscus lens. The super-hemispherical meniscus lens has a reduction-side surface positioned on the reduction side and an enlargement-side surface positioned on the enlargement side. The reduction-side surface is a concave curved surface on the reduction side, and the enlargement-side surface is a convex curved surface on the enlargement side, having a positive refractive power. The curved surface of the enlargement-side surface is a curved surface extending beyond a hemisphere. An intersection of the reduction-side surface and an optical axis of the optical system is positioned closer to the enlargement side than the reduction-side conjugate point, and a reduction-side intersection is positioned closer to the reduction side than the reduction-side conjugate point,

where

the reduction-side intersection is an intersection of a reduction-side virtual plane and the optical axis of the optical system,

the reduction-side virtual plane is a plane including an intersection of an outside ray and the reduction-side surface and being orthogonal to the optical axis of the optical system, and

the outside ray is a light ray passing through a position farthest from a center of the reduction-side surface, among light rays contributing to image formation.

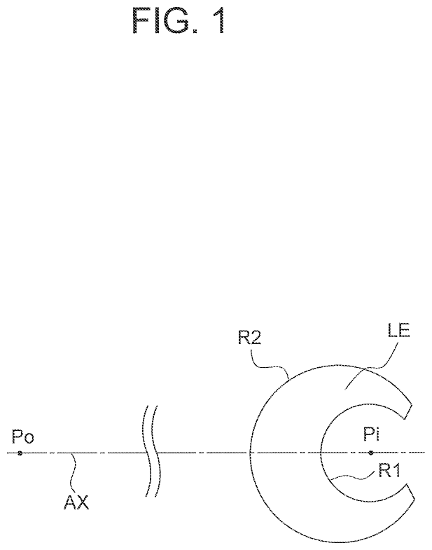

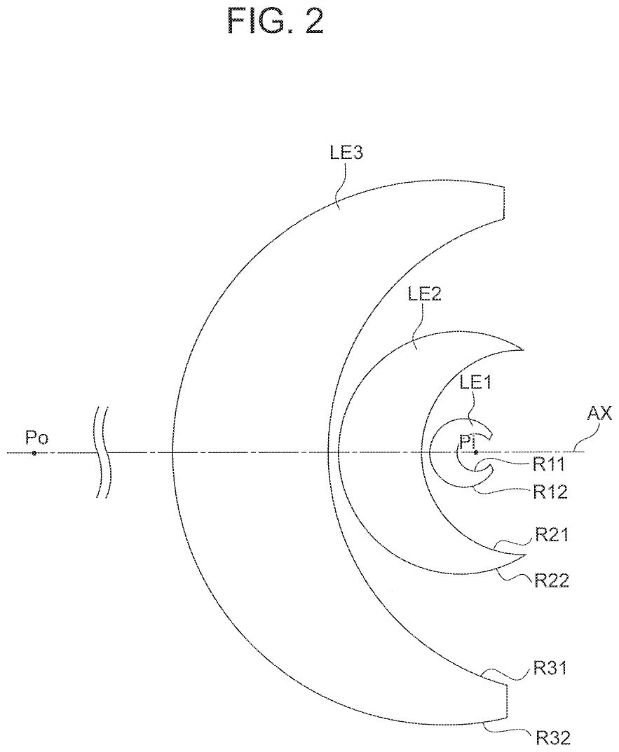

FIG. 1 is a diagram illustrating a first example of the optical system of the present embodiment. FIG. 2 is a diagram illustrating a second example of the optical system of the present embodiment. In the first example, the optical system includes one meniscus lens. In the second example, the optical system includes three meniscus lenses.

The optical system of the present embodiment is an optical system in which an enlargement-side conjugate point Po and a reduction-side conjugate point Pi are conjugate. The enlargement-side conjugate point Po and the reduction-side conjugate point Pi are positioned on an optical axis AX of the optical system.

The enlargement-side conjugate point Po is positioned on the enlargement side, and the reduction-side conjugate point Pi is positioned on the reduction side. The distance from the optical system to the enlargement-side conjugate point Po is longer than the distance from the optical system to the reduction-side conjugate point Pi.

In the optical system of the present embodiment, it is possible to position an object at the enlargement-side conjugate point Po. In this case, an optical image of the object is formed at the reduction-side conjugate point Pi. Thus, it is possible to use the optical system of the present embodiment, for example, as a photographic lens of a camera. The object is not necessarily positioned at the enlargement-side conjugate point Po. For example, the object may be positioned at infinity.

Furthermore, in the optical system of the present embodiment, it is possible to position an object at the reduction-side conjugate point Pi. In this case, an optical image of the object is formed at the enlargement-side conjugate point Po. Thus, it is possible to use the optical system of the present embodiment, for example, as an objective lens of a microscope, an eyepiece optical system of VR goggles, or a projection lens of a projector. The optical image is not necessarily formed at the enlargement-side conjugate point Po. For example, the optical image may be formed at infinity.

When a spherical surface is used for a lens surface, the lens surface is represented by an arc in the sectional view of the lens. It is possible to represent the range of the lens surface by the length of the arc. It is possible to represent the length of the arc by the angle (hereinafter referred to as “arc angle”) formed between both ends of the arc and the center of the circle.

Here, a curved surface having an arc angle greater than 180° is referred to as a curved surface extending beyond a hemisphere. A meniscus lens having a curved surface extending beyond a hemisphere is referred to as a super-hemispherical meniscus lens.

As illustrated in FIG. 1, the optical system of the first example has a meniscus lens LE. The meniscus lens LE has a reduction-side surface R1 positioned on the reduction side and an enlargement-side surface R2 positioned on the enlargement side. The reduction-side surface R1 is a concave curved surface on the reduction side. The enlargement-side surface R2 is a convex curved surface on the enlargement side, having a positive refractive power.

In the meniscus lens LE, the enlargement-side surface R2 is a curved surface extending beyond a hemisphere. Thus, the meniscus lens LE is a super-hemispherical meniscus lens.

As illustrated in FIG. 2, the optical system of the second example includes a meniscus lens LE1, a meniscus lens LE2, and a meniscus lens LE3.

The meniscus lens LE1 has a reduction-side surface R11 positioned on the reduction side and an enlargement-side surface R12 positioned on the enlargement side. The reduction-side surface R11 is a concave curved surface on the reduction side. The enlargement-side surface R12 is a convex curved surface on the enlargement side, having a positive refractive power.

In the meniscus lens LE1, the enlargement-side surface R12 is a curved surface extending beyond a hemisphere. Thus, the meniscus lens LE1 is a super-hemispherical meniscus lens.

The meniscus lens LE2 has a reduction-side surface R21 positioned on the reduction side and an enlargement-side surface R22 positioned on the enlargement side. The reduction-side surface R21 is a concave curved surface on the reduction side. The enlargement-side surface R22 is a convex curved surface on the enlargement side, having a positive refractive power.

In the meniscus lens LE2, the enlargement-side surface R22 is a curved surface extending beyond a hemisphere. Thus, the meniscus lens LE2 is a super-hemispherical meniscus lens.

The meniscus lens LE3 has a reduction-side surface R31 positioned on the reduction side and an enlargement-side surface R32 positioned on the enlargement side. The reduction-side surface R31 is a concave curved surface on the reduction side. The enlargement-side surface R32 is a convex curved surface on the enlargement side, having a positive refractive power.

In the meniscus lens LE3, the enlargement-side surface R32 is a curved surface extending beyond a hemisphere. Thus, the meniscus lens LE3 is a super-hemispherical meniscus lens.

As described above, the enlargement-side conjugate point Po and the reduction-side conjugate point Pi are conjugate. When a luminous body is disposed at the enlargement-side conjugate point Po, light is incident on the enlargement-side surface and thereafter emerged from the reduction-side surface. The light emerged from the reduction-side surface reaches the reduction-side conjugate point Pi.

On the other hand, when a luminous body is disposed at the reduction-side conjugate point Pi, light is incident on the reduction-side surface and thereafter emerged from the enlargement-side surface. The light emerged from the enlargement-side surface reaches the enlargement-side conjugate point Po. In the following description, it is assumed that a luminous body is disposed at the reduction-side conjugate point Pi.

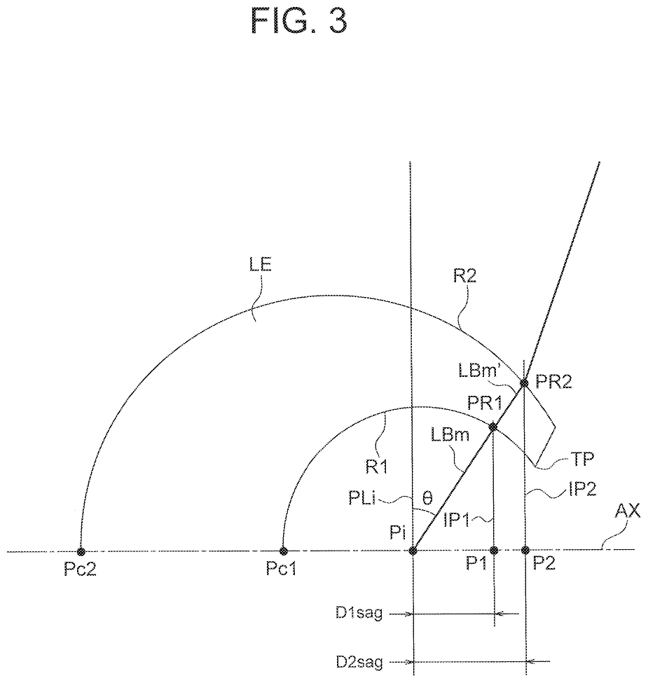

FIG. 3 is a diagram illustrating an outside ray in the optical system of the first example. When a luminous body is disposed at the reduction-side conjugate point Pi, light coming toward the meniscus lens LE and light going away from the meniscus lens LE are emitted from the reduction-side conjugate point Pi. The light coming toward the meniscus lens LE is light traveling toward the enlargement side, and the light going away from the meniscus lens LE is light traveling toward the reduction side.

If it is possible to make the light going away from the meniscus lens LE as well as the light coming toward the meniscus lens LE to contribute to image formation, it is possible to implement an optical system that is bright and has a high resolving power.

As illustrated in FIG. 3, an intersection Pc1 of the reduction-side surface R1 and the optical axis AX is positioned closer to the enlargement side than the reduction-side conjugate point Pi. In this case, a part of the reduction-side surface R1 is positioned in the traveling direction of light coming toward the meniscus lens LE. Therefore, in the optical system of the first example, it is possible to make light coming toward the meniscus lens LE to contribute to image formation.

A reduction-side intersection P1 is the intersection of a reduction-side virtual plane IP1 and the optical axis AX. The reduction-side virtual plane IP1 is a plane including an intersection PR1 of an outside ray LBm and the reduction-side surface R1 and being orthogonal to the optical axis AX. The outside ray LBm is a light ray passing through a position farthest from the center of the reduction-side surface R1, among light rays contributing to image formation. As just described, the reduction-side intersection P1 is determined by the outside ray LBm. The center of the reduction-side surface R1 is the intersection Pc1.

When the reduction-side intersection P1 is positioned closer to the enlargement side than the reduction-side conjugate point Pi, the outside ray LBm comes toward the meniscus lens LE. When the reduction-side intersection P1 is positioned closer to the reduction side than the reduction-side conjugate point Pi, the outside ray LBm goes away from the meniscus lens LE. As just described, the position of the reduction-side intersection P1 and the position of the reduction-side conjugate point Pi are relevant to the direction of the outside ray LBm.

As the reduction-side intersection P1 goes away from the reduction-side conjugate point Pi toward the reduction side, an angle θ increases. The angle θ is the angle formed between a reduction-side conjugate plane PLi and the outside ray LBm. As the angle θ increases, the proportion of light rays reaching the reduction-side surface of the meniscus lens LE increases. As a result, the quantity of light increases.

In the optical system of the first example, the reduction-side intersection P1 is positioned closer to the reduction side than the reduction-side conjugate point Pi is. Thus, the outside ray LBm is a light ray going away from the meniscus lens LE. Since the outside ray LBm reaches the reduction-side surface R1, the light ray going away from the meniscus lens LE reaches the reduction-side surface R1. Since the outside ray LBm is a light ray contributing to image formation, it is possible to make the light ray going away from the meniscus lens LE to contribute to image formation in the optical system of the first example.

As just described, in the optical system of the first example, it is possible to make light going away from the optical system as well as light coming toward the optical system to contribute to image formation. Thus, it is possible to implement an optical system that is bright and has a high resolving power.

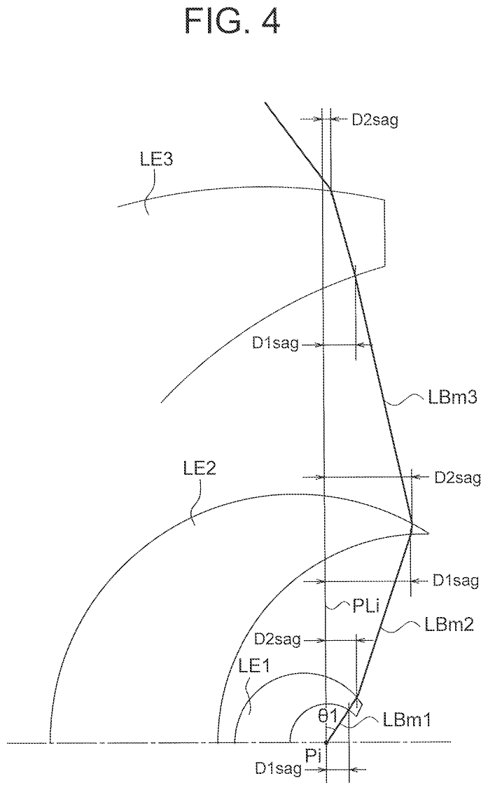

FIG. 4 is a diagram illustrating an outside ray in the optical system of the second example. When a luminous body is disposed at the reduction-side conjugate point Pi, light coming toward the meniscus lens LE1 and light going away from the meniscus lens LE1 are emitted from the reduction-side conjugate point Pi. If it is possible to make the light going away from the meniscus lens LE1 as well as the light coming toward the meniscus lens LE1 to contribute to image formation, it is possible to implement an optical system that is bright and has a high resolving power.

The meniscus lens LE1 is described. The intersection of the reduction-side surface of the meniscus lens LE1 and the optical axis is positioned closer to the enlargement side than the reduction-side conjugate point Pi. In this case, a part of the reduction-side surface of the meniscus lens LE1 is positioned in the traveling direction of light coming toward the meniscus lens LE1. Therefore, in the optical system of the second example, it is possible to make light coming toward the meniscus lens LE1 to contribute to image formation.

A reduction-side intersection of the meniscus lens LE1 is the intersection of a reduction-side virtual plane of the meniscus lens LE1 and the optical axis. The reduction-side virtual plane of the meniscus lens LE1 is a plane including the intersection of an outside ray LBm1 and the reduction-side surface of the meniscus lens LE1 and being orthogonal to the optical axis. The outside ray LBm1 is a light ray passing through a position farthest from the center of the reduction-side surface of the meniscus lens LE1, among light rays contributing to image formation. The reduction-side intersection of the meniscus lens LE1 is determined by the outside ray LBm1.

When the reduction-side intersection is positioned closer to the enlargement side than the reduction-side conjugate point Pi, the outside ray LBm1 comes toward the meniscus lens LE1. When the reduction-side intersection is positioned closer to the reduction side than the reduction-side conjugate point Pi, the outside ray LBm1 goes away from the meniscus lens LE1. As just described, the position of the reduction-side intersection and the position of the reduction-side conjugate point Pi are relevant to the direction of the outside ray LBm1.

As the reduction-side intersection goes away from the reduction-side conjugate point Pi toward the reduction side, an angle θ1 increases. The angle θ1 is the angle formed between the reduction-side conjugate plane and the outside ray LBm1. As the angle θ1 increases, the proportion of light rays reaching the reduction-side surface of the meniscus lens LE1 increases. As a result, the quantity of light increases.

In the meniscus lens LE1, the reduction-side intersection is positioned closer to the reduction side than the reduction-side conjugate point Pi is. Thus, the outside ray LBm1 is a light ray going away from the meniscus lens LE1. Since the outside ray LBm1 reaches the reduction-side surface of the meniscus lens LE1, it follows that the light ray going away from the meniscus lens LE1 reaches the reduction-side surface of the meniscus lens LE1. Since the outside ray LBm1 is a light ray contributing to image formation, it is possible that the light ray going away from the meniscus lens LE1 contributes to image formation in the optical system of the second example.

The meniscus lens LE2 is described. A reduction-side intersection of the meniscus lens LE2 is the intersection of a reduction-side virtual plane of the meniscus lens LE2 and the optical axis. The reduction-side virtual plane of the meniscus lens LE2 is a plane including the intersection of an outside ray LBm2 and the reduction-side surface of the meniscus lens LE2 and being orthogonal to the optical axis. The outside ray LBm2 is a light ray passing through a position farthest from the center of the reduction-side surface of the meniscus lens LE2, among light rays contributing to image formation. The reduction-side intersection of the meniscus lens LE2 is determined by the outside ray LBm2.

The reduction-side surface of the meniscus lens LE2 is not positioned closest to the reduction-side conjugate point Pi. Thus, in the meniscus lens LE2, the position of the reduction-side intersection and the position of the reduction-side conjugate point Pi are relevant to the direction of the outside ray LBm2.

In the meniscus lens LE2, the reduction-side intersection is positioned closer to the reduction side than the reduction-side conjugate point Pi. Therefore, compared with when the reduction-side intersection is positioned closer to the enlargement side than the reduction-side conjugate point Pi, it is possible to reduce change in direction of the outside ray LBm2 relative to the direction of the outside ray LBm1.

If the change in direction of the outside ray LBm2 relative to the direction of the outside ray LBm1 is large, a large aberration occurs. In order to reduce the change in direction, for example, the direction of the outside ray LBm1 may be changed such that the angle θ1 is reduced. However, in this case, the proportion of light rays reaching the reduction-side surface of the meniscus lens LE1 is reduced. As a result, the quantity of light is reduced.

In the meniscus lens LE2, it is possible to reduce the change in direction of the outside ray LBm2 relative to the direction of the outside ray LBm1 without reducing the angle θ1. Thus, it is possible to suppress reduction of the quantity of light and to suppress occurrence of aberration.

The meniscus lens LE3 is described. A reduction-side intersection of the meniscus lens LE3 is the intersection of a reduction-side virtual plane of the meniscus lens LE3 and the optical axis. The reduction-side virtual plane of the meniscus lens LE3 is a plane including the intersection of an outside ray LBm3 and the reduction-side surface of the meniscus lens LE3 and being orthogonal to the optical axis. The outside ray LBm3 is a light ray passing through a position farthest from the center of the reduction-side surface of the meniscus lens LE3, among light rays contributing to image formation. The reduction-side intersection of the meniscus lens LE3 is determined by the outside ray LBm3.

The reduction-side surface of the meniscus lens LE3 is not positioned closest to the reduction-side conjugate point Pi. Thus, in the meniscus lens LE3, the position of the reduction-side intersection and the position of the reduction-side conjugate point Pi are relevant to the direction of the outside ray LBm3.

In the meniscus lens LE3, the reduction-side intersection is positioned closer to the reduction side than the reduction-side conjugate point Pi. Therefore, compared with when the reduction-side intersection is positioned closer to the enlargement side than the reduction-side conjugate point Pi, it is possible to reduce change in direction of the outside ray LBm3 relative to the direction of the outside ray LBm2.

If the change in direction of the outside ray LBm3 relative to the direction of the outside ray LBm2 is large, a large aberration occurs. In order to reduce the change in direction, for example, the direction of the outside ray LBm1 may be changed such that the angle θ1 is reduced. However, in this case, the proportion of light rays reaching the reduction-side surface of the meniscus lens LE1 is reduced. As a result, the quantity of light is reduced.

In the meniscus lens LE3, it is possible to reduce the change in direction of the outside ray LBm3 relative to the direction of the outside ray LBm2 without reducing the angle θ1. Thus, it is possible to suppress reduction of the quantity of light and to suppress occurrence of aberration.

As just described, in the optical system of the second example, it is possible to make light going away from the optical system as well as light coming toward the optical system to contribute to image formation. Thus, it is possible to implement an optical system that is bright and has a high resolving power. In addition, it is possible to implement an optical system in which occurrence of aberration is suppressed.

In the optical system of the present embodiment, it is preferable that the reduction-side conjugate point be positioned inside a spherical segment of the reduction-side surface.

A spherical segment surface is a surface of a spherical surface partially cut off. In the optical system of the first example, as illustrated in FIG. 3, the sectional profile of the reduction-side surface R1 is defined by an arc connecting the intersection Pc1, the intersection PR1, and a tip end TP. The surface of a spherical surface partially cut off is formed by rotating this arc around the optical axis AX. Thus, it is possible to say that the reduction-side surface R1 is a spherical segment surface.

In the optical system of the first example, the reduction-side conjugate point Pi is positioned closer to the enlargement side than the tip end TP. The enlargement side relative to the tip end TP is inside the spherical segment surface. Thus, it is possible to say that the reduction-side conjugate point Pi is positioned inside the spherical segment surface.

When the reduction-side conjugate point Pi is positioned inside the spherical segment surface, the intersection Pc1 is positioned closer to the enlargement side than the reduction-side conjugate point Pi, and the reduction-side intersection P1 is positioned closer to the reduction side than the reduction-side conjugate point Pi. In this case, it is possible to make light going away from the optical system as well as light coming toward the optical system to contribute to image formation. Thus, it is possible to implement an optical system that is bright and has a high resolving power.

It is possible to make the reduction-side surface R1 an aspheric surface. In this case, the spherical segment surface is represented based on a sphere represented by a paraxial radius of curvature.

In the optical system of the present embodiment, it is preferable that an enlargement-side intersection be positioned closer to the reduction side than the reduction-side conjugate point,

where

the enlargement-side intersection is an intersection of an enlargement-side virtual plane and the optical axis of the optical system,

the enlargement-side virtual plane is a plane including an intersection of a predetermined outside ray and the enlargement-side surface and being orthogonal to the optical axis of the optical system, and

the predetermined outside ray is a light ray after the outside ray passes through the reduction-side surface.

The optical system of the first example is described. As illustrated in FIG. 3, an enlargement-side intersection P2 is the intersection of an enlargement-side virtual plane IP2 and the optical axis AX. The enlargement-side virtual plane IP2 is a plane including an intersection PR2 of an outside ray LBm′ and the enlargement-side surface R2 and being orthogonal to the optical axis AX. As just described, the enlargement-side intersection P2 is determined by the outside ray LBm′. The outside ray LBm′ is a light ray after the outside ray LBm passes through the reduction-side surface R1.

As described above, the outside ray LBm is a light ray passing through the position farthest from the center of the reduction-side surface, among light rays contributing to image formation. Thus, it is possible to say that the outside ray LBm′ is a light ray passing through the position farthest from the center of the enlargement-side surface, among light rays contributing to image formation.

The enlargement-side surface R2 is not positioned closest to the reduction-side conjugate point Pi. Thus, the position of the enlargement-side intersection P2 and the position of the reduction-side conjugate point Pi are relevant to the outside ray LBm′.

In the meniscus lens LE, the enlargement-side intersection P2 is positioned closer to the reduction side than the reduction-side conjugate point Pi is. Therefore, compared with when the enlargement-side intersection P2 is positioned closer to the enlargement side than the reduction-side conjugate point Pi, it is possible to reduce change in direction of the outside ray LBm′ relative to the direction of the outside ray LBm.

If the change in direction of the outside ray LBm′ relative to the direction of the outside ray LBm is large, a large aberration occurs. In order to reduce the change in direction, for example, the direction of the outside ray LBm may be changed such that the angle θ is reduced. However, in this case, the proportion of light rays reaching the reduction-side surface R1 is reduced. As a result, the quantity of light is reduced.

In the meniscus lens LE, it is possible to reduce the change in direction of the outside ray LBm′ relative to the direction of the outside ray LBm without reducing the angle θ. Thus, it is possible to suppress reduction of the quantity of light and to suppress occurrence of aberration.

As just described, in the optical system of the first example, it is possible to make light going away from the optical system as well as light coming toward the optical system to contribute to image formation. Thus, it is possible to implement an optical system that is bright and has a high resolving power.

The enlargement-side surface R2 is not positioned closest to the reduction-side conjugate point Pi, similarly to the reduction-side surface of the meniscus lens LE1, the reduction-side surface of the meniscus lens LE2, and the reduction-side surface of the meniscus lens LE3. Thus, in the enlargement-side surface R2, an operation effect similar to that of these reduction surfaces is produced.

The optical system of the second example is described. However, a detailed description is omitted. The meniscus lens LE1 is described, and a description of the meniscus lens LE2 and the meniscus lens LE3 is omitted.

In the meniscus lens LE1, the enlargement-side intersection is the intersection of the enlargement-side virtual plane and the optical axis AX. The enlargement-side virtual plane is a plane including the intersection of a predetermined outside ray and the enlargement-side surface and being orthogonal to the optical axis AX. As just described, the enlargement-side intersection is determined by the predetermined outside ray. The predetermined outside ray is a light ray after the outside ray LBm1 passes through the reduction-side surface.

As described above, the outside ray LBm1 is a light ray contributing to image formation. Since the predetermined outside ray is a light ray after the outside ray LBm1 passes through the reduction-side surface, the predetermined outside ray is a light ray contributing to image formation. The outside ray LBm1 is a light ray passing through the position farthest from the center of the reduction-side surface. Thus, the predetermined outside ray passes through the position farthest from the center of the enlargement-side surface.

The enlargement-side surface of the meniscus lens LE1 is not positioned closest to the reduction-side conjugate point Pi. Thus, the position of the enlargement-side intersection and the position of the reduction-side conjugate point Pi are relevant to the direction of the predetermined outside ray.

In the meniscus lens LE1, the enlargement-side intersection is positioned closer to the reduction side than the reduction-side conjugate point. Therefore, compared with when the enlargement-side intersection is positioned closer to the enlargement side than the reduction-side conjugate point, it is possible to reduce change in direction of the predetermined outside ray relative to the direction of the outside ray LBm1.

If the change in direction of the predetermined outside ray relative to the direction of the outside ray LBm1 is large, a large aberration occurs. In order to reduce the change in direction, for example, the direction of the outside ray LBm1 may be changed such that the angle θ1 is reduced. However, in this case, the proportion of light rays reaching the reduction-side surface is reduced. As a result, the quantity of light is reduced.

In the meniscus lens LE, it is possible to reduce the change in direction of the outside ray LBm′ relative to the direction of the outside ray LBm without reducing the angle θ. Thus, it is possible to suppress reduction of the quantity of light and to suppress occurrence of aberration.

The enlargement-side surface of the meniscus lens LE1 is not positioned closest to the reduction-side conjugate point Pi, similarly to the reduction-side surface of the meniscus lens LE1, the reduction-side surface of the meniscus lens LE2, and the reduction-side surface of the meniscus lens LE3. Thus, in the enlargement-side surface of the meniscus lens LE1, an operation effect similar to that of these reduction surfaces is produced.

The enlargement-side surface of the meniscus lens LE2 and the enlargement-side surface of the meniscus lens LE3 are also not positioned closest to the reduction-side conjugate point Pi. Thus, in the enlargement-side surface of the meniscus lens LE2 and the enlargement-side surface of the meniscus lens LE3, an operation effect similar to that of the enlargement-side surface of the meniscus lens LE1 is produced.

As just described, in the optical system of the second example, it is possible to make light going away from the optical system as well as light coming toward the optical system to contribute to image formation. Thus, it is possible to implement an optical system that is bright and has a high resolving power.

In the optical system of the present embodiment, it is preferable that the following Conditional Expression (1) be satisfied:

0 (mm)<D1sag (1)

where

D1sag is a distance between the reduction-side conjugate point and the reduction-side intersection.

Conditional Expression (1) is a conditional expression for the amount of protrusion of the reduction-side surface toward the reduction side. The amount of protrusion is the distance between the reduction-side conjugate point Pi and the reduction-side intersection and determined by the reduction-side conjugate point Pi as a reference. When the reduction-side intersection is positioned closer to the reduction side than the reduction-side conjugate point Pi, the amount of protrusion has a positive value.

When Conditional Expression (1) is satisfied, it is possible to make light going away from the optical system to contribute to image formation. Thus, it is possible to implement an optical system that is bright and has a high resolving power.

FIG. 3 illustrates the amount of protrusion of the reduction-side surface in the optical system of the first example. The amount of protrusion D1sag is the distance between the reduction-side conjugate point Pi and the reduction-side intersection P1. Since the reduction-side intersection P1 is positioned closer to the reduction side than the reduction-side conjugate point Pi, the amount of protrusion D1sag has a positive value.

FIG. 4 illustrates the amount of protrusion of the reduction-side surface in the optical system of the second example. The amount of protrusion D1sag in the meniscus lens LE1 is the distance between the reduction-side conjugate point Pi and the reduction-side intersection of the meniscus lens LE1. In the meniscus lens LE1, the reduction-side intersection is positioned closer to the reduction side than the reduction-side conjugate point Pi. Thus, the amount of protrusion D1sag has a positive value.

The amount of protrusion D1sag in the meniscus lens LE2 is the distance between the reduction-side conjugate point Pi and the reduction-side intersection of the meniscus lens LE2. In the meniscus lens LE2, the reduction-side intersection is positioned closer to the reduction side than the reduction-side conjugate point Pi. Thus, the amount of protrusion D1sag has a positive value.

The amount of protrusion D1sag in the meniscus lens LE3 is the distance between the reduction-side conjugate point Pi and the reduction-side intersection of the meniscus lens LE3. In the meniscus lens LE3, the reduction-side intersection is positioned closer to the reduction side than the reduction-side conjugate point Pi. Thus, the amount of protrusion D1sag has a positive value.

In the optical system of the present embodiment, it is preferable that the following Conditional Expression (2) be satisfied:

0 (mm)<D2sag (2)

where

D2sag is a distance between the reduction-side conjugate point and the enlargement-side intersection.

Conditional Expression (2) is a conditional expression for the amount of protrusion of the enlargement-side surface toward the reduction side. The amount of protrusion is the distance between the reduction-side conjugate point Pi and the enlargement-side intersection and determined by the reduction-side conjugate point Pi as a reference. When the enlargement-side intersection is positioned closer to the reduction side than the reduction-side conjugate point Pi, the amount of protrusion has a positive value.

When Conditional Expression (2) is satisfied, it is possible to make light going away from the optical system to contribute to image formation. Thus, it is possible to implement an optical system that is bright and has a high resolving power.

FIG. 3 illustrates the amount of protrusion of the enlargement-side surface in the optical system of the first example. The amount of protrusion D2sag is the distance between the reduction-side conjugate point Pi and the enlargement-side intersection P2. Since the enlargement-side intersection P2 is positioned closer to the reduction side than the reduction-side conjugate point Pi, the amount of protrusion D2sag has a positive value.

FIG. 4 illustrates the amount of protrusion of the enlargement-side surface in the optical system of the second example. The amount of protrusion D2sag in the meniscus lens LE1 is the distance between the reduction-side conjugate point Pi and the enlargement-side intersection of the meniscus lens LE1. In the meniscus lens LE1, the enlargement-side intersection is positioned closer to the reduction side than the reduction-side conjugate point Pi. Thus, the amount of protrusion D2sag has a positive value.

The amount of protrusion D2sag in the meniscus lens LE2 is the distance between the reduction-side conjugate point Pi and the enlargement-side intersection of the meniscus lens LE2. In the meniscus lens LE2, the enlargement-side intersection is positioned closer to the reduction side than the reduction-side conjugate point Pi. Thus, the amount of protrusion D2sag has a positive value.

The amount of protrusion D2sag in the meniscus lens LE3 is the distance between the reduction-side conjugate point Pi and the enlargement-side intersection of the meniscus lens LE3. In the meniscus lens LE3, the enlargement-side intersection is positioned closer to the reduction side than the reduction-side conjugate point Pi. Thus, the amount of protrusion D2sag has a positive value.

The technical significance of Conditional Expression (1) and the technical significance of Conditional Expression (2) are on the premise that a luminous body is disposed at the reduction-side conjugate point Pi. It is also possible to dispose a luminous body at the enlargement-side conjugate point Po, as described above. In this case, light reaches the reduction-side conjugate point Pi from the enlargement side. Thus, it follows that “light going away from the optical system” is “light reaching the optical system from a position closer to the reduction side than the reduction-side conjugate point Pi”.

It is preferable that the optical system of the present embodiment include at least one super-hemispherical meniscus lens that satisfies both of Conditional Expression (1) and Conditional Expression (2).

The technical significance of Conditional Expression (1) and the technical significance of Conditional Expression (2) are as described above.

When at least two super-hemispherical meniscus lenses are disposed in the optical system, it is possible to refract light using at least four refraction surfaces. In this case, since it is possible to bend light little by little, it is possible to suppress occurrence of spherical aberration. Furthermore, it is possible to use glass materials having different optical characteristics for the glass materials of the super-hemispherical meniscus lenses. Therefore, it is possible to favorably correct chromatic aberration.

In the optical system of the present embodiment, it is preferable that a predetermined lens be the super-hemispherical meniscus lens positioned closest to the reduction-side conjugate point, and the following Conditional Expression (3) be satisfied:

0<R1/F<0.6 (3)

where

R1 is a radius of curvature of the reduction-side surface of the predetermined lens, and

F is a focal length of the optical system.

Conditional Expression (3) is a conditional expression for the radius of curvature of the reduction-side surface. Light going away from the optical system reaches the reduction-side surface. Thus, it is possible to say that Conditional Expression (3) is a conditional expression for making light going away from the optical system to reach the reduction-side surface.

In a case in which a value falls below a lower limit value of Conditional Expression (3), the reduction-side surface becomes a convex curved surface on the reduction side. In the optical system of the present embodiment, the reduction-side surface must be a concave curved surface on the reduction side. Thus, the value does not fall below the lower limit value of Conditional Expression (3).

In a case in which the value exceeds an upper limit value of Conditional Expression (3), the radius of curvature of the reduction-side surface becomes too large. In this case, even when the reduction-side intersection is positioned closer to the reduction side than the reduction-side conjugate point, it is not possible to increase the distance between the reduction-side intersection and the reduction-side conjugate point. Therefore, light rays that can reach the reduction-side surface among light rays going away from the optical system become fewer.

In the optical system of the present embodiment, it is preferable that a predetermined lens be the super-hemispherical meniscus lens positioned closest to the reduction-side conjugate point, and the following Conditional Expression (4) be satisfied:

0<R2/F<0.6 (4)

where

R2 is a radius of curvature of the enlargement-side surface of the predetermined lens, and

F is a focal length of the optical system.

Conditional Expression (4) is a conditional expression for the radius of curvature of the enlargement-side surface. Light reaching the reduction-side surface is directed toward the enlargement-side surface. Conditional Expression (4) is a conditional expression for making light to reach the enlargement-side surface from the reduction-side surface.

In a case in which a value falls below a lower limit value of Conditional Expression (4), the enlargement-side surface becomes a concave curved surface on the enlargement side. In the optical system of the present embodiment, the enlargement-side surface must be a convex curved surface on the enlargement side. Thus, the value does not fall below the lower limit value of Conditional Expression (4).

In a case in which the value exceeds an upper limit value of Conditional Expression (4), the radius of curvature of the enlargement-side surface becomes too large. As described above, the enlargement-side surface is a curved surface extending beyond a hemisphere. Therefore, when the radius of curvature of the enlargement-side surface is too large, the portion extending beyond a hemisphere becomes small.

When light travels from the enlargement side to the reduction-side conjugate point, it is difficult to refract light reaching the enlargement-side surface greatly on the enlargement-side surface, if the portion extending beyond a hemisphere is small. Therefore, total reflection occurs on the reduction-side surface. As a result, it is not possible to make light to travel from the reduction-side surface toward the reduction-side conjugate point.

Embodiments and examples of an optical system will be described below in detail by referring to the accompanying diagrams. However, the present disclosure is not restricted to the embodiments and the examples described below.

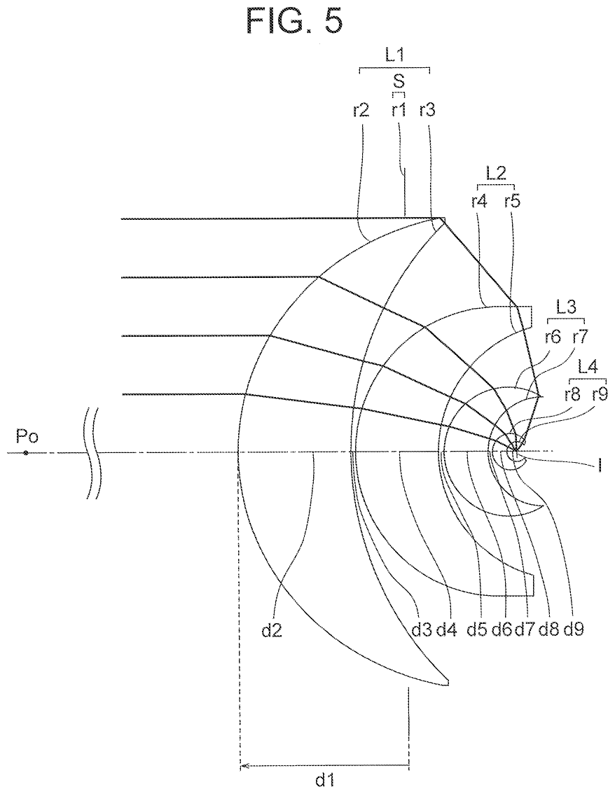

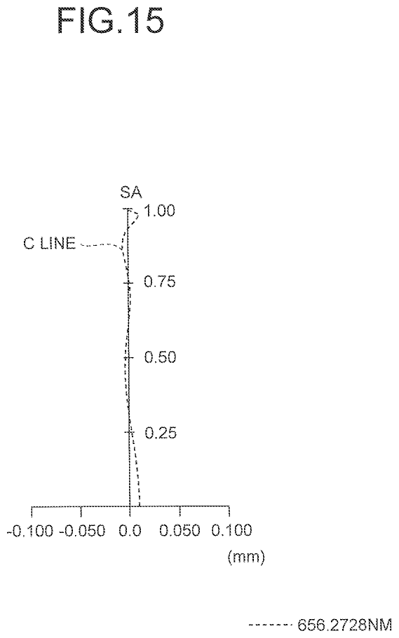

An optical system of Example 1 is illustrated in FIG. 5. FIG. 5 is a lens sectional view of the optical system of Example 1. In FIG. 5, the left side in the drawing sheet is the enlargement side and the right side is the reduction side. FIG. 15 is an aberration diagram of spherical aberration of the optical system of Example 1.

The optical system of Example 1 is an image pickup optical system. In the optical system of Example 1, an object is positioned on the enlargement side. Thus, an optical image I of the object is formed at a reduction-side conjugate point. FIG. 5 illustrates a state in which light from the object positioned at infinity is collected at the reduction-side conjugate point.

The image pickup optical system includes, in order from the enlargement side, a negative meniscus lens L1 having a convex surface facing the enlargement side, a negative meniscus lens L2 having a convex surface facing the enlargement side, a negative meniscus lens L3 having a convex surface facing the enlargement side, and a negative meniscus lens L4 having a convex surface facing the enlargement side. An aperture stop S is positioned closer to the reduction side than a surface apex of an enlargement-side surface of the negative meniscus lens L1.

An enlargement-side surface of the negative meniscus lens L2, an enlargement-side surface of the negative meniscus lens L3, and an enlargement-side surface of the negative meniscus lens L4 are curved surfaces extending beyond a hemisphere. Thus, the negative meniscus lens L2, the negative meniscus lens L3, and the negative meniscus lens L4 are super-hemispherical meniscus lenses. In the optical system of Example 1, three super-hemispherical meniscus lenses are disposed on the reduction side.

An aspheric surface is provided at the enlargement-side surface of the negative meniscus lens L1.

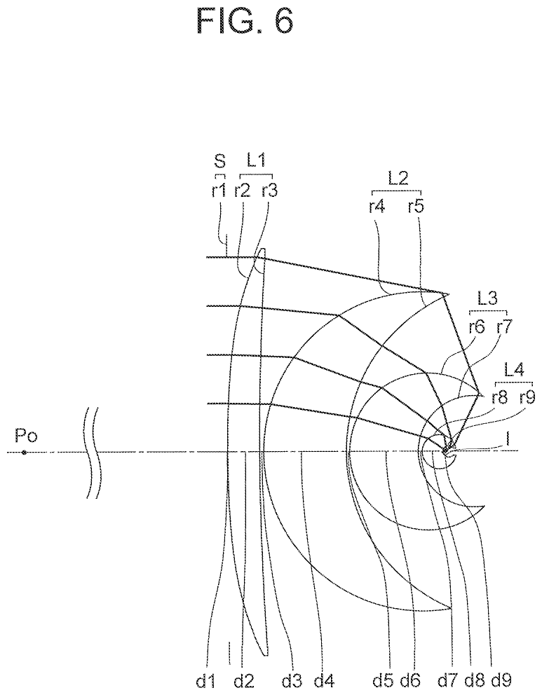

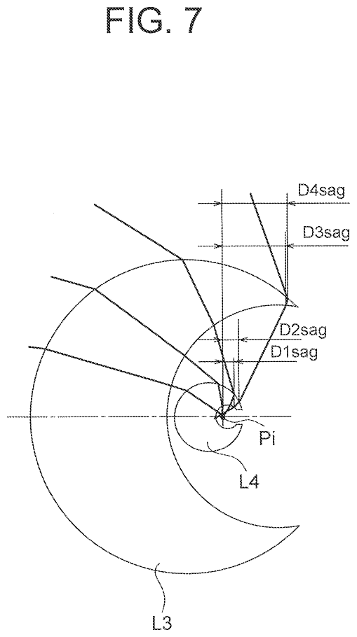

An optical system of Example 2 is illustrated in FIG. 6. FIG. 6 is a lens sectional view of the optical system of Example 2. Furthermore, a partial sectional view of the optical system of Example 2 is illustrated in FIG. 7. FIG. 7 illustrates lenses positioned near a reduction-side conjugate point Pi. In FIG. 6 and FIG. 7, the left side in the drawing sheet is the enlargement side and the right side is the reduction side.

The optical system of Example 2 is an illumination optical system. In the optical system of Example 2, an object is positioned on the reduction side, for example, at the reduction-side conjugate point Pi. Thus, an optical image of the object is formed on the enlargement side. FIG. 6 illustrates a state in which light from the object, for example, light emitted from a light source becomes parallel light on the enlargement side. Furthermore, an optical image I in the optical system of Example 1 is illustrated. In the optical system of Example 2, an object is disposed at the position of the optical image I.

The illumination optical system includes, in order from the enlargement side, a negative meniscus lens L1 having a convex surface facing the enlargement side, a negative meniscus lens L2 having a convex surface facing the enlargement side, a negative meniscus lens L3 having a convex surface facing the enlargement side, and a negative meniscus lens L4 having a convex surface facing the enlargement side. An aperture stop S is positioned at a surface apex of an enlargement-side surface of the negative meniscus lens L1.

An enlargement-side surface of the negative meniscus lens L3 and an enlargement-side surface of the negative meniscus lens L4 are curved surfaces extending beyond a hemisphere. Thus, the negative meniscus lens L3 and the negative meniscus lens L4 are super-hemispherical meniscus lenses. In the optical system of Example 2, two super-hemispherical meniscus lenses are disposed on the reduction side.

An aspheric surface is provided at the enlargement-side surface of the negative meniscus lens L1.

FIG. 7 illustrates the amount of protrusion in the negative meniscus lens L3 and the amount of protrusion in the negative meniscus lens L4.

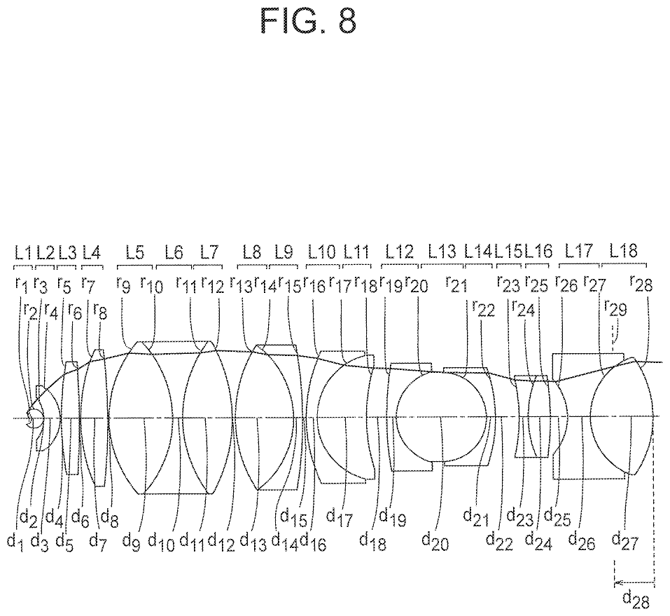

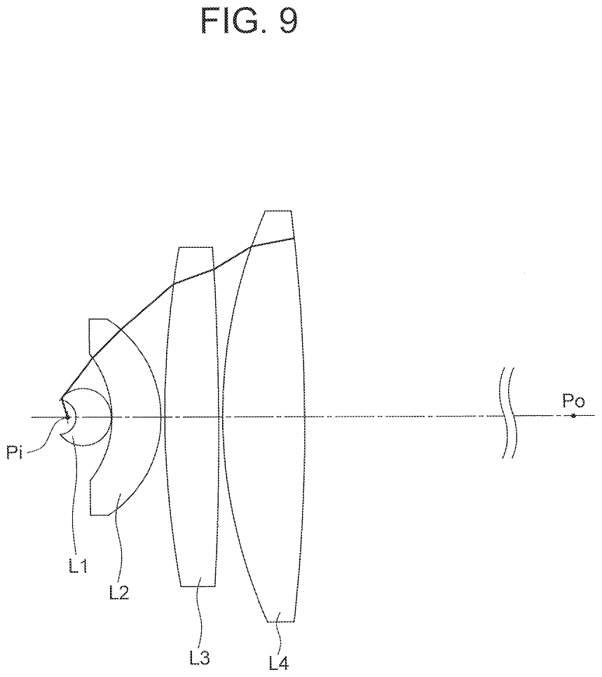

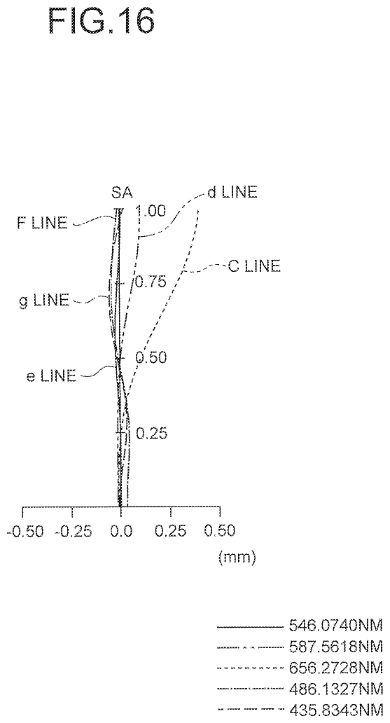

An optical system of Example 3 is illustrated in FIG. 8. FIG. 8 is a lens sectional view of the optical system of Example 3. Furthermore, a partial sectional view of the optical system of Example 3 is illustrated in FIG. 9. FIG. 9 illustrates lenses positioned near a reduction-side conjugate point Pi. In FIG. 8 and FIG. 9, the left side in the drawing sheet is the reduction side and the right side is the enlargement side. FIG. 16 is an aberration diagram of spherical aberration of the optical system of Example 3.

The optical system of Example 3 is a dry-type microscope objective lens. In the optical system of Example 3, an object is positioned on the reduction side, for example, at the reduction-side conjugate point Pi. Thus, an optical image of the object is formed on the enlargement side. The optical system of Example 3 is an infinity-corrected objective lens. FIG. 8 illustrates a state in which light from the object becomes parallel light on the enlargement side.

The microscope objective lens includes, in order from the reduction side, a negative meniscus lens L1 having a convex surface facing the enlargement side, a negative meniscus lens L2 having a convex surface facing the enlargement side, a biconvex positive lens L3, and a biconvex positive lens L4.

The microscope objective lens further includes a biconvex positive lens L5, a biconcave negative lens L6, a biconvex positive lens L7, a biconvex positive lens L8, a negative meniscus lens L9 having a convex surface facing the enlargement side, a negative meniscus lens L10 having a convex surface facing the reduction side, and a positive meniscus lens L11 having a convex surface facing the reduction side.

The biconvex positive lens L5, the biconcave negative lens L6, and the biconvex positive lens L7 are cemented. The biconvex positive lens L8 and the negative meniscus lens L9 are cemented. The negative meniscus lens L10 and the positive meniscus lens L11 are cemented.

The microscope objective lens further includes a negative meniscus lens L12 having a convex surface facing the reduction side, a biconvex positive lens L13, a negative meniscus lens L14 having a convex surface facing the enlargement side, a biconcave negative lens L15, a biconvex positive lens L16, a biconcave negative lens L17, and a biconvex positive lens L18.

The negative meniscus lens L12, the biconvex positive lens L13, and the negative meniscus lens L14 are cemented. The biconcave negative lens L15 and the biconvex positive lens L16 are cemented. The biconcave negative lens L17 and the biconvex positive lens L18 are cemented.

As illustrated in FIG. 9, an enlargement-side surface of the negative meniscus lens L1 is a curved surface extending beyond a hemisphere. Thus, the negative meniscus lens L1 is a super-hemispherical meniscus lens. In the optical system of Example 3, one super-hemispherical meniscus lens is disposed on the reduction side.

A method of calculating a resolving power of the optical system includes a method of calculating a resolving power of the optical system using a numerical aperture and a method of calculating a resolving power of the optical system using a pupil diameter. Both methods are methods by approximation.

In the method of calculating a resolving power of the optical system using a numerical aperture, the resolving power δ is given by the following Expression (A):

δ=(0.61×λ)/NA (A)

where

λ is a wavelength, and

NA is a numerical aperture.

In the method of calculating a resolving power of the optical system using a pupil diameter, the resolving power δ is given by the following Expression (B):

δ=1.22λ/D (B)

where

λ is a wavelength, and

D is a pupil diameter.

In the optical system of Example 3, since the angular aperture exceeds 90°, the resolving power δ is calculated using a pupil diameter. The larger the pupil diameter is, the smaller the resolving power δ is. In the optical system of Example 3, the resolving power δ is calculated using the pupil diameter on the enlargement side.

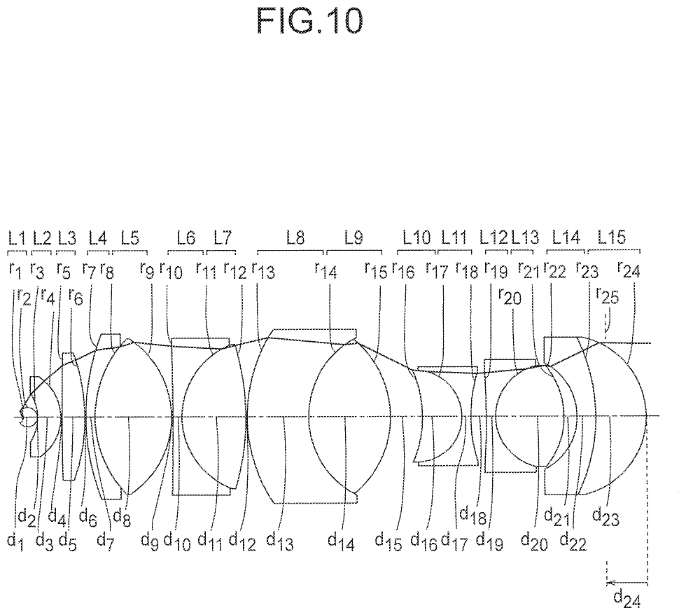

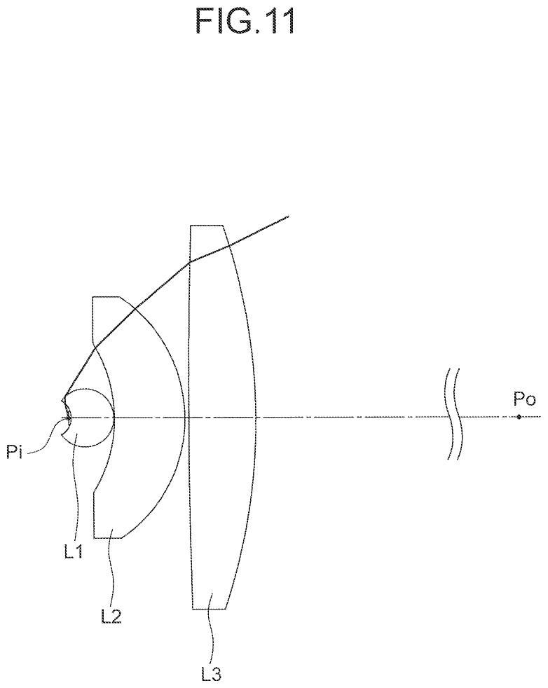

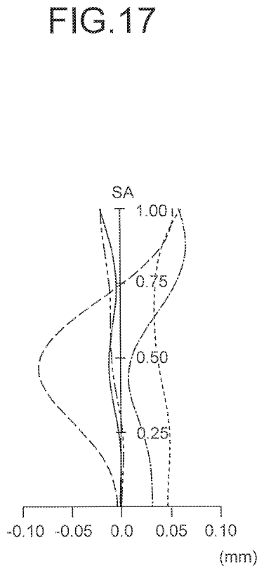

An optical system of Example 4 is illustrated in FIG. 10. FIG. 10 is a lens sectional view of the optical system of Example 4. Furthermore, a partial sectional view of the optical system of Example 4 is illustrated in FIG. 11. FIG. 11 illustrates lenses positioned near a reduction-side conjugate point Pi. In FIG. 10 and FIG. 11, the left side in the drawing sheet is the reduction side and the right side is the enlargement side. FIG. 17 is an aberration diagram of spherical aberration of the optical system of Example 4.

The optical system of Example 4 is a water immersion-type microscope objective lens. In the optical system of Example 4, an object is positioned on the reduction side, for example, at the reduction-side conjugate point Pi. Thus, an optical image of the object is formed on the enlargement side. The optical system of Example 4 is an infinity-corrected objective lens. FIG. 10 illustrates a state in which light from the object becomes parallel light on the enlargement side.

The microscope objective lens includes, in order from the reduction side, a negative meniscus lens L1 having a convex surface facing the enlargement side, a negative meniscus lens L2 having a convex surface facing the enlargement side, and a biconvex positive lens L3.

The microscope objective lens further includes a negative meniscus lens L4 having a convex surface facing the reduction side, a biconvex positive lens L5, a biconcave negative lens L6, a biconvex positive lens L7, a negative meniscus lens L8 having a convex surface facing the reduction side, and a biconvex positive lens L9.

The negative meniscus lens L4 and the biconvex positive lens L5 are cemented. The biconcave negative lens L6 and the biconvex positive lens L7 are cemented. The negative meniscus lens L8 and the biconvex positive lens L9 are cemented.

The microscope objective lens further includes a positive meniscus lens L10 having a convex surface facing the enlargement side, a biconcave negative lens L11, a biconcave negative lens L12, a biconvex positive lens L13, a negative meniscus lens L14 having a convex surface facing the enlargement side, and a positive meniscus lens L15 having a convex surface facing the enlargement side.

The positive meniscus lens L10 and the biconcave negative lens L11 are cemented. The biconcave negative lens L12 and the biconvex positive lens L13 are cemented. The negative meniscus lens L14 and the positive meniscus lens L15 are cemented.

As illustrated in FIG. 11, an enlargement-side surface of the negative meniscus lens L1 is a curved surface extending beyond a hemisphere. Thus, the negative meniscus lens L1 is a super-hemispherical meniscus lens. In the optical system of Example 4, one super-hemispherical meniscus lens is disposed on the reduction side.

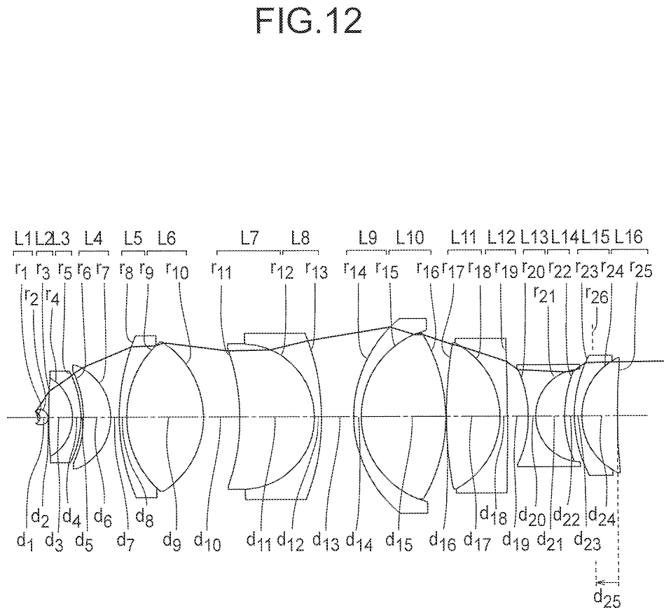

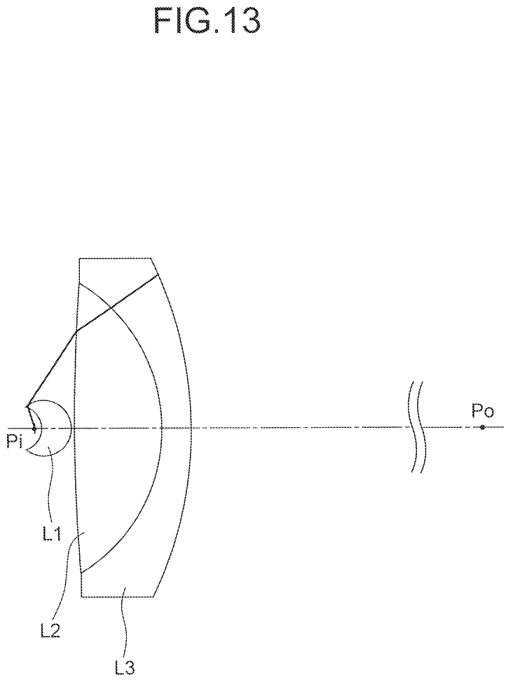

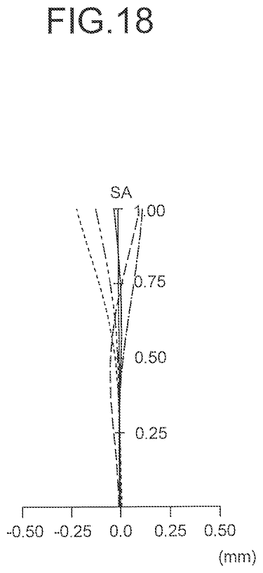

An optical system of Example 5 is illustrated in FIG. 12. FIG. 13 is a lens sectional view of the optical system of Example 5. Furthermore, a partial sectional view of the optical system of Example 5 is illustrated in FIG. 13. FIG. 13 illustrates lenses positioned near a reduction-side conjugate point Pi. In FIG. 12 and FIG. 13, the left side in the drawing sheet is the reduction side and the right side is the enlargement side. FIG. 18 is an aberration diagram of spherical aberration of the optical system of Example 5.

The optical system of Example 5 is a water immersion-type microscope objective lens. In the optical system of Example 5, an object is positioned on the reduction side, for example, at the reduction-side conjugate point Pi. Thus, an optical image of the object is formed on the enlargement side. The optical system of Example 5 is an infinity-corrected objective lens. FIG. 12 illustrates a state in which light from the object becomes parallel light on the enlargement side.

The microscope objective lens includes, in order from the reduction side, a negative meniscus lens L1 having a convex surface facing the enlargement side, a biconvex positive lens L2, a negative meniscus lens L3 having a convex surface facing the enlargement side, and a positive meniscus lens L4 having a convex surface facing the enlargement side. The biconvex positive lens L2 and the negative meniscus lens L3 are cemented.

The microscope objective lens further includes a negative meniscus lens L5 having a convex surface facing the reduction side, a biconvex positive lens L6, a positive meniscus lens L7 having a convex surface facing the enlargement side, a negative meniscus lens L8 having a convex surface facing the enlargement side, a negative meniscus lens L9 having a convex surface facing the reduction side, and a biconvex positive lens L10.

The negative meniscus lens L5 and the biconvex positive lens L6 are cemented. The positive meniscus lens L7 and the negative meniscus lens L8 are cemented. The negative meniscus lens L9 and the biconvex positive lens L10 are cemented.

The microscope objective lens further includes a biconvex positive lens L11, a negative meniscus lens L12 having a convex surface facing the enlargement side, a biconcave negative lens L13, a positive meniscus lens L14 having a convex surface facing the reduction side, a negative meniscus lens L15 having a convex surface facing the reduction side, and a positive meniscus lens L16 having a convex surface facing the reduction side.

The biconvex positive lens L11 and the negative meniscus lens L12 are cemented. The biconcave negative lens L13 and the positive meniscus lens L14 are cemented. The negative meniscus lens L15 and the positive meniscus lens L16 are cemented.

As illustrated in FIG. 13, an enlargement-side surface of the negative meniscus lens L1 is a curved surface extending beyond a hemisphere. Thus, the negative meniscus lens L1 is a super-hemispherical meniscus lens. In the optical system of Example 5, one super-hemispherical meniscus lens is disposed on the reduction side.

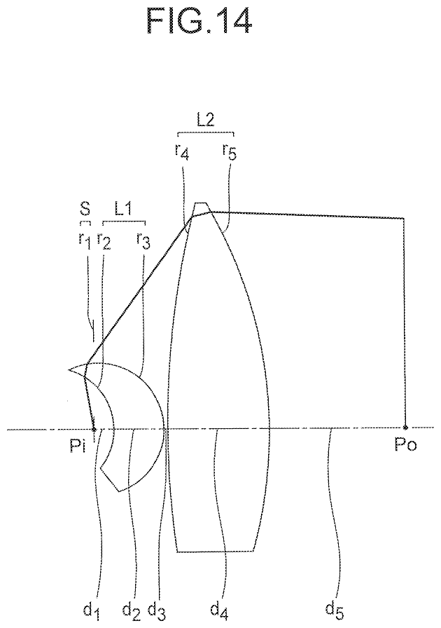

An optical system of Example 6 is illustrated in FIG. 14. FIG. 14 is a lens sectional view of the optical system of Example 6. In FIG. 14, the left side in the drawing sheet is the reduction side and the right side is the enlargement side.

The optical system of Example 6 is an eyepiece optical system. In the optical system of Example 6, an object is positioned at an enlargement-side conjugate point Po. Thus, an optical image of the object is formed on the reduction side. FIG. 14 illustrates a state in which light from the object positioned at the enlargement-side conjugate point Po, for example, light from a display element, reaches the reduction-side conjugate point Pi.

The eyepiece optical system includes, in order from the reduction side, a negative meniscus lens L1 having a convex surface facing the enlargement side and a biconvex positive lens L2. An aperture stop S is positioned on the reduction side of the negative meniscus lens L1.

An enlargement-side surface of the negative meniscus lens L1 is a curved surface extending beyond a hemisphere. Thus, the negative meniscus lens L1 is a super-hemispherical meniscus lens. In the optical system of Example 6, one super-hemispherical meniscus lens is disposed on the reduction side.

Numerical data of each example described above is shown below. In Surface data, r denotes radius of curvature of each lens surface, d denotes a distance between respective lens surfaces, ne denotes a refractive index of each lens for a e-line, νd denotes an Abbe number for each lens and * denotes an aspherical surface.

Moreover, in Various data, f denotes a focal length of the optical system, FNO. denotes an F number, ω denotes a half angle of view, EDP denotes a diameter of a pupil, θout denotes a half angle of emergence, φEXP denotes a diameter of an exit pupil, ONA denote an angular aperture, OBH denote an object height, ωmax denotes a maximum angle of view, ωeye denotes an angle of view of both eyes, IH denote an image height. Unit of length is mm and unit of angle is degree.

A shape of an aspherical surface is defined by the following expression where the direction of the optical axis is represented by z, the direction orthogonal to the optical axis is represented by y, a conical coefficient is represented by K, aspherical surface coefficients are represented by A4, A6, A8, A10, A12 . . . .

Z=(y²/r)/[1+{1−(1+k)(y/r)²}^{1/2}]+A4 y⁴+A6 y⁶+A8 y⁸+A10 y¹⁰+A12 y¹²+ . . . .

Further, in the aspherical surface coefficients, ‘e−n’ (where, n is an integral number) indicates ‘10⁻ⁿ’. Moreover, these symbols are commonly used in the following numerical data for each example.

### Example 1

Unit mm
Surface data

| Surface no. | r | d | ne | νd |
|---|---|---|---|---|
| Object plane | ∞ | ∞ | | |
| 1(Stop) | ∞ | −36.000 | | |
| 2* | 46.733 | 24.117 | 1.8830 | 40.7 |
| 3 | 67.843 | 1.000 | | |
| 4 | 30.711 | 17.649 | 1.8830 | 40.7 |
| 5 | 27.274 | 1.198 | | |
| 6 | 13.709 | 9.313 | 1.8830 | 40.7 |
| 7 | 11.550 | 1.000 | | |
| 8 | 3.889 | 3.076 | 1.8830 | 40.7 |
| 9 | 2.138 | 2.000 | | |
| Image plane | ∞ | | | |

Aspherical surface data

2nd surface
k = −1.4700e−001

Various data

| | |
|---|---|
| f | 25.88 |
| Fno | 0.261 |
| ω | ±0.1 |
| EPD | 99.0 |
| θout | 125 |

### Example 2

Unit mm
Surface data

| Surface no. | r | d | ne | νd |
|---|---|---|---|---|
| Object plane | ∞ | ∞ | | |
| 1(Stop) | ∞ | 0.000 | | |
| 2* | 328.349 | 8.265 | 1.4879 | 70.4 |
| 3 | 759.429 | 1.000 | | |
| 4 | 40.598 | 20.949 | 2.0033 | 28.3 |
| 5 | 43.306 | 1.000 | | |
| 6 | 19.983 | 17.480 | 2.0033 | 28.3 |
| 7 | 14.189 | 1.000 | | |
| 8 | 4.391 | 5.287 | 2.0033 | 28.3 |
| 9 | 1.500 | 0.905 | | |
| Image plane | ∞ | | | |

Aspherical surface data

2nd surface
k = 0.0
A4 = 7.0674e−007, A6 = −9.6354e−012

Various data

| | |
|---|---|
| f | 20.39 |
| Fno | 0.206 |
| ω | ±0.1 |
| EPD | 99.0 |
| θout | 150 |

### Example 3

Unit mm
Surface data

| Surface no. | r | d | ne | νd |
|---|---|---|---|---|
| Object plane | ∞ | 0.198 | | |
| 1 | −0.441 | 0.920 | 1.5163 | 64.1 |
| 2 | −0.728 | 0.013 | | |
| 3 | −2.583 | 1.265 | 1.8830 | 40.7 |
| 4 | −2.953 | 0.100 | | |
| 5 | 24.297 | 1.370 | 1.5831 | 59.4 |
| 6 | −69.936 | 0.100 | | |
| 7 | 12.754 | 2.102 | 1.5174 | 52.4 |
| 8 | −43.793 | 0.100 | | |
| 9 | 8.748 | 4.889 | 1.4387 | 94.9 |
| 10 | −8.452 | 0.767 | 1.6377 | 42.4 |
| 11 | 9.685 | 3.798 | 1.4387 | 94.9 |
| 12 | −11.646 | 0.239 | | |
| 13 | 10.154 | 4.480 | 1.4387 | 94.9 |
| 14 | −6.874 | 0.700 | 1.6377 | 42.4 |
| 15 | −32.003 | 0.284 | | |
| 16 | 11.532 | 0.859 | 1.6541 | 39.7 |
| 17 | 4.848 | 3.818 | 1.4387 | 94.9 |
| 18 | 13.502 | 1.551 | | |
| 19 | 24.553 | 0.731 | 1.7582 | 34.8 |
| 20 | 3.575 | 6.900 | 1.7412 | 32.2 |
| 21 | −3.421 | 0.700 | 1.7437 | 32.4 |
| 22 | −11.348 | 1.816 | | |
| 23 | −13.678 | 0.700 | 1.7638 | 42.9 |
| 24 | 7.897 | 1.688 | 1.5286 | 47.7 |
| 25 | −21.077 | 1.316 | | |
| 26 | −4.261 | 1.778 | 1.6150 | 44.0 |
| 27 | 4.784 | 4.817 | 1.6205 | 46.8 |
| 28 | −7.743 | −3.000 | | |
| 29 | ∞ | | | |

Various data

| | |
|---|---|
| f | 4.236 |
| φEχP | 8.45 |
| θNA | 106.64 |
| OBH | 0.01 |

### Example 4

Unit mm
Surface data

| Surface no. | r | d | ne | νd |
|---|---|---|---|---|
| Object plane | ∞ | 0.055 | 1.3330 | 55.7 |
| 1 | −0.500 | 1.095 | 1.5163 | 64.1 |
| 2 | −0.740 | 0.014 | | |
| 3 | −3.598 | 1.793 | 1.8830 | 40.7 |
| 4 | −3.676 | 0.100 | | |
| 5 | 171.081 | 1.725 | 1.6385 | 55.4 |
| 6 | −14.814 | 0.100 | | |
| 7 | 17.417 | 0.700 | 1.6377 | 42.4 |
| 8 | 8.469 | 5.921 | 1.4387 | 94.9 |
| 9 | −7.089 | 0.100 | | |
| 10 | −285.010 | 0.701 | 1.6377 | 42.4 |
| 11 | 5.896 | 4.919 | 1.4387 | 94.9 |
| 12 | −18.905 | 0.105 | | |
| 13 | 12.207 | 4.692 | 1.6377 | 42.4 |
| 14 | 6.717 | 6.334 | 1.4387 | 94.9 |
| 15 | −7.611 | 2.454 | | |
| 16 | −8.993 | 3.041 | 1.5481 | 45.8 |
| 17 | −3.527 | 0.700 | 1.5638 | 60.6 |
| 18 | 11.532 | 1.190 | | |
| 19 | −47.136 | 0.703 | 1.6223 | 53.1 |
| 20 | 3.958 | 5.260 | 1.5827 | 46.4 |
| 21 | −6.000 | 1.007 | | |
| 22 | −4.547 | 1.444 | 1.7859 | 44.2 |
| 23 | −13.421 | 3.851 | 1.4387 | 94.9 |
| 24 | −6.174 | −3.000 | | |
| 25 | ∞ | | | |

Various data

| | |
|---|---|
| f | 4.218 |
| φEχP | 11.19 |
| θNA | 104.5 |
| OBH | 0.01 |

### Example 5

Unit mm
Surface data

| Surface no. | r | d | ne | νd |
|---|---|---|---|---|
| Object plane | ∞ | 0.241 | 1.3330 | 55.7 |
| 1 | −0.810 | 1.086 | 1.8830 | 40.7 |
| 2 | −1.015 | 0.120 | | |
| 3 | 71.412 | 3.194 | 1.4387 | 94.9 |
| 4 | −6.117 | 1.070 | 1.5578 | 53.8 |
| 5 | −13.831 | 0.346 | | |
| 6 | −14.879 | 3.698 | 1.4387 | 94.9 |
| 7 | −7.506 | 1.179 | | |
| 8 | 27.083 | 1.000 | 1.7205 | 34.7 |
| 9 | 13.411 | 10.351 | 1.4387 | 94.9 |
| 10 | −11.859 | 4.913 | | |
| 11 | −27.342 | 10.000 | 1.4387 | 94.9 |
| 12 | −9.748 | 1.000 | 1.6377 | 42.4 |
| 13 | −28.985 | 4.331 | | |
| 14 | 16.809 | 1.000 | 1.7205 | 34.7 |
| 15 | 11.884 | 11.410 | 1.4387 | 94.9 |
| 16 | −21.149 | 0.100 | | |
| 17 | 55.604 | 7.156 | 1.8340 | 37.1 |
| 18 | −11.014 | 1.000 | 1.7995 | 42.2 |
| 19 | −365.106 | 2.803 | | |
| 20 | −15.025 | 1.000 | 1.8830 | 40.7 |
| 21 | 6.250 | 3.934 | 1.7847 | 25.7 |
| 22 | 15.779 | 1.296 | | |
| 23 | 17.255 | 1.000 | 1.8929 | 20.4 |
| 24 | 8.567 | 4.772 | 2.0033 | 28.3 |
| 25 | 82.326 | −3.000 | | |
| 26 | ∞ | | | |

Various data

| | |
|---|---|
| f | 4.307 |
| φEχP | 14.36 |
| θNA | 108.00 |
| OBH | 0.01 |

The optical system of Example 3, the optical system of Example 4, and the optical system of Example 5 are an infinity-corrected objective lenses. The infinity-corrected objective lens is used with a tube lens. Examples of the tube lens are given below.

Surface data

| Surface no. | r | d | ne | νd |
|---|---|---|---|---|
| 1 | 68.754 | 7.732 | 1.4875 | 70.2 |
| 2 | −37.568 | 3.474 | 1.8061 | 40.9 |
| 3 | −102.848 | 0.697 | | |
| 4 | 84.310 | 6.024 | 1.8340 | 37.1 |
| 5 | −50.710 | 3.030 | 1.6445 | 40.8 |
| 6 | 40.662 | 150.000 | | |
| Image plane | ∞ | | | |

### Example 6

Unit mm
Surface data

| Surface no. | r | d | ne | νd |
|---|---|---|---|---|
| Object plane | ∞ | ∞ | | |
| 1(Stop) | ∞ | 5.083 | | |
| 2 | −15.631 | 12.725 | 1.9590 | 17.5 |
| 3 | −16.793 | 1.000 | | |
| 4 | 221.773 | 26.090 | 1.9590 | 17.5 |
| 5 | −111.714 | 34.663 | | |
| Image plane | ∞ | | | |

Various data

| | |
|---|---|
| f | 29.30 |
| φEχP | 5.00 |
| ωmax | 100.00 |
| ωeye | 200.00 |
| IH | 53.74 |

Values of conditional expressions in each example are given below.

| | Example1 | Example2 | Example3 |
|---|---|---|---|
| (1)D1sag | 1.264 | 1.420 | 0.127 |
| | 4.775 | 8.137 | |
| | 1.744 | | |
| (2)D2sag | 1.748 | 2.137 | 0.134 |
| | 4.849 | 8.397 | |
| | 0.420 | | |
| (3)R1/F | −0.083 | −0.074 | −0.104 |
| (4)R2/F | −0.150 | −0.215 | −0.172 |
| | Example4 | Example5 | Example6 |
| (1)D1sag | 0.091 | 0.241 | 5.123 |
| (2)D2sag | 0.105 | 0.249 | 5.027 |
| (3)R1/F | −0.119 | −0.188 | −0.533 |
| (4)R2/F | −0.175 | −0.236 | −0.573 |

Values of parameters are given below.

| | Example1 | Example2 | Example3 |
|---|---|---|---|
| R1 | −2.138 | −1.500 | −0.441 |
| R2 | −3.889 | −4.391 | −0.728 |
| F | 25.881 | 20.390 | 4.236 |
| | Example4 | Example5 | Example6 |
| R1 | −0.500 | −0.81 | −15.631 |
| R2 | −0.740 | −1.015 | −16.793 |
| F | 4.218 | 4.307 | 29.303 |

An optical apparatus of the present embodiment includes the optical system described above and an image sensor disposed at the reduction-side conjugate point.

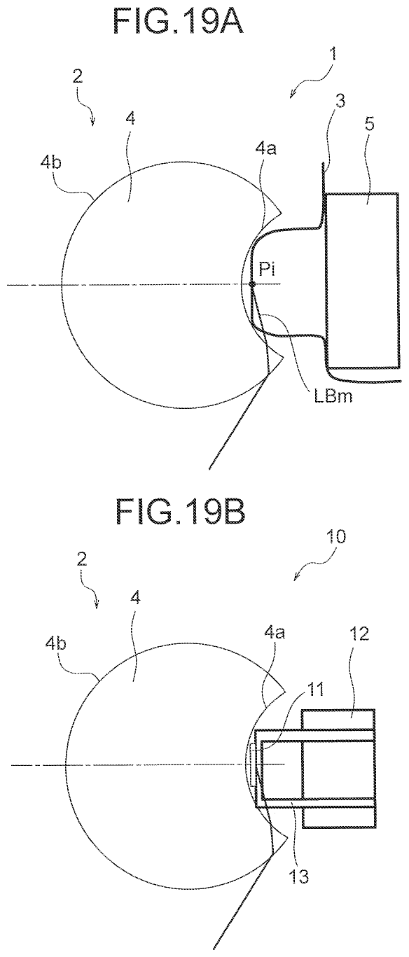

FIG. 19A and FIG. 19B are diagrams illustrating a first example of the optical apparatus of the present embodiment. The optical apparatus of the first example is an image pickup apparatus. FIG. 19A is a diagram illustrating a first example of the image pickup apparatus. FIG. 19B is a diagram illustrating a second example of the image pickup apparatus.

The image pickup apparatus of the first example is described. An image pickup apparatus 1 includes an image pickup optical system 2 and an image sensor 3. The image pickup optical system 2 includes a lens 4. For example, it is possible to use a thin-film image sensor as the image sensor 3. The image sensor 3 is held by a holding member 5.

In the lens 4, a reduction-side surface 4a is a concave curved surface on the reduction side, and an enlargement-side surface 4b is a convex curved surface on the enlargement side. The enlargement-side surface 4b is a curved surface extending beyond a hemisphere. Thus, the lens 4 is a super-hemispherical meniscus lens. In the image pickup optical system 2, one super-hemispherical meniscus lens is disposed on the reduction side.

In the lens 4, the intersection of the reduction-side surface 4a and the optical axis of the image pickup optical system 2 is positioned closer to the enlargement side than the reduction-side conjugate point Pi. The reduction-side intersection is positioned closer to the reduction side than the reduction-side conjugate point Pi. Thus, it is possible to make the light ray LBm going away from the lens 4 to contribute to image formation.

When an object is positioned at the reduction-side conjugate point Pi, the light ray LBm represents a light ray going away from the lens 4. However, in the image pickup apparatus 1, the object is positioned on the enlargement side. In this case, light travels from the enlargement side to the reduction side. Thus, in the image pickup apparatus 1, the light ray LBm is a light ray coming toward the lens 4.

As illustrated in FIG. 19A, the light ray LBm reaches the reduction-side conjugate point Pi from a position closer to the reduction side than the reduction-side conjugate point Pi. In the image pickup apparatus 1, it is possible to make such a light ray to contribute to image formation.

The image pickup apparatus of the second example is described. An image pickup apparatus 10 includes an image pickup optical system 2 and an image sensor 11. The image pickup optical system 2 includes a lens 4. For example, it is possible to use a back-illuminated image sensor as the image sensor 11. The image sensor 11 is held by a holding member 12 and a holding member 13.

The holding member 13 is held by the holding member 12. A front end portion of the holding member 13 protrudes from the holding member 12. The image sensor 11 is disposed at the front end portion of the holding member 13.

The front end portion of the holding member 13 is formed of a material that allows transmission of light. Thus, it is possible to make the light ray LBm illustrated in FIG. 19A to reach the image sensor 11. At the front end portion of the holding member 13, a though hole may be provided at a place through which the light ray LBm passes.

The image pickup optical system 2 is used also in the image pickup apparatus 10. Thus, it is possible to make the light ray LBm to contribute to image formation even in the image pickup apparatus 10, although a detailed description thereof is omitted.

The optical apparatus of the present embodiment includes the optical system described above and a light source disposed at the reduction-side conjugate point.

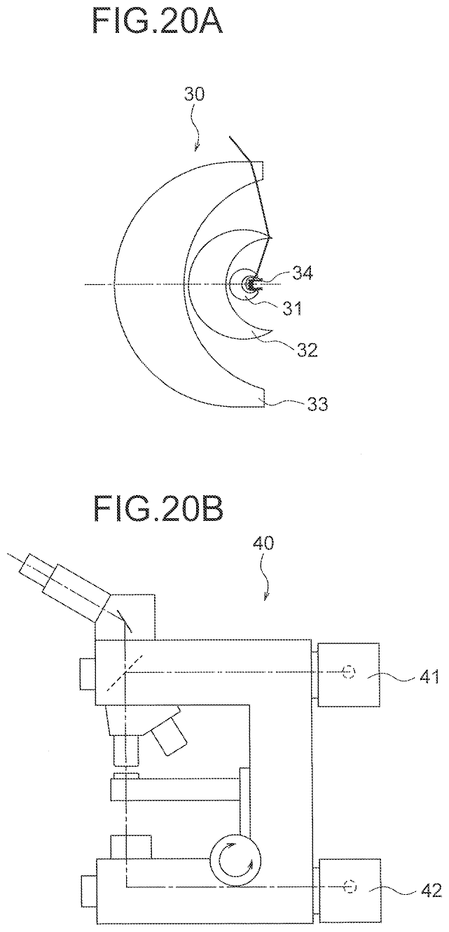

FIG. 20 is a diagram illustrating a second example of the optical apparatus of the present embodiment. The optical apparatus of the second example is a microscope. FIG. 20A is a diagram illustrating a part of an illumination optical system. FIG. 20B is a diagram illustrating a microscope.

An illumination optical system 30 includes a lens 31, a lens 32, and a lens 33. The illumination optical system 30 further includes a plurality of lenses. These lenses are not illustrated in FIG. 20A. A light source 34 is disposed at a reduction-side conjugate point of the illumination optical system 30.

It is possible to dispose a luminous body or a light-emerging surface at the position of the light source 34. For example, it is possible to use a halogen lamp or an LED as the luminous body. For example, it is possible to use a light-emerging surface of an optical fiber bundle as the light-emerging surface.

In the lens 31 and the lens 32, a reduction-side surface is a concave curved surface on the reduction side, and an enlargement-side surface is a convex curved surface on the enlargement side. The enlargement-side surface is a curved surface extending beyond a hemisphere. Thus, the lens 31 and the lens 32 are super-hemispherical meniscus lenses. In the illumination optical system 30, two super-hemispherical meniscus lenses are disposed on the reduction side.

In the lens 31 and the lens 32, an intersection of the reduction-side surface and the optical axis of the illumination optical system 30 is positioned closer to the enlargement side than the reduction-side conjugate point. A reduction-side intersection is positioned closer to the reduction side than the reduction-side conjugate point. Thus, it is possible to use a light ray going away from the lens 31 as illumination light. As a result, it is possible to implement bright illumination.

A microscope 40 includes an epi-illumination device 41 and a transmitted illumination device 42. The illumination optical system 30 is used for each of the epi-illumination device 41 and the transmitted illumination device 42.

The optical apparatus of the present embodiment includes the optical system described above and a holding mechanism configured to position an object at the reduction-side conjugate point.

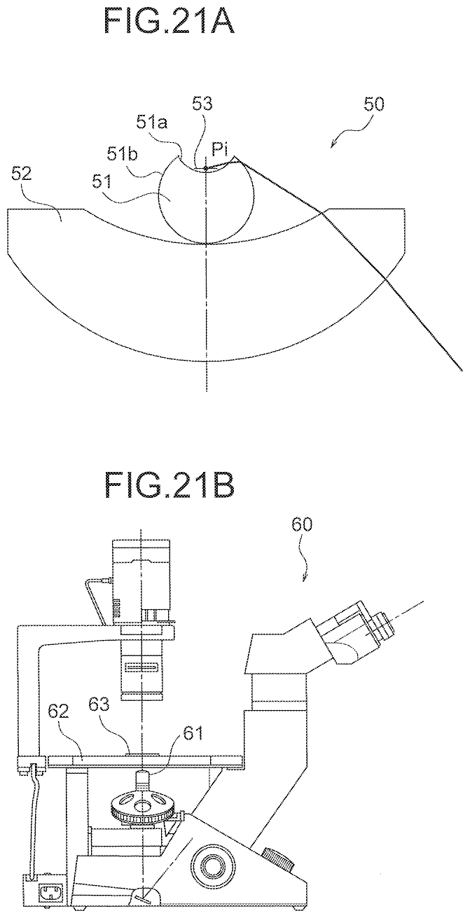

FIG. 21 is a diagram illustrating a third example of the optical system of the present embodiment. The optical apparatus of the third example is a microscope. FIG. 21A is a diagram illustrating a part of a microscope objective lens. FIG. 21B is a diagram illustrating a microscope.

A microscope objective lens 50 includes a lens 51 and a lens 52. The microscope objective lens 50 further includes a plurality of lenses. These lenses are not illustrated in FIG. 21A. A specimen 53 is positioned at a reduction-side conjugate point Pi.

In the lens 51, a reduction-side surface 51a is a concave curved surface on the reduction side, and an enlargement-side surface 51b is a convex curved surface on the enlargement side. The enlargement-side surface 51b is a curved surface extending beyond a hemisphere. Thus, the lens 51 is a super-hemispherical meniscus lens. In the microscope objective lens 50, one super-hemispherical meniscus lens is disposed on the reduction side.

In the lens 51, an intersection of the reduction-side surface 51a and the optical axis of the microscope objective lens 50 is positioned closer to the enlargement side than the reduction-side conjugate point Pi. A reduction-side intersection is positioned closer to the reduction side than the reduction-side conjugate point Pi. Thus, it is possible to make a light ray going away from the lens 51 to contribute to image formation.

A microscope 60 includes a microscope objective lens 61 and a stage 62. The microscope objective lens 61 is disposed under the stage 62. The stage 62 is the holding mechanism configured to position an object at the reduction-side conjugate point. A specimen 63 is placed on the stage 62. The specimen 63 is held by a holding member.

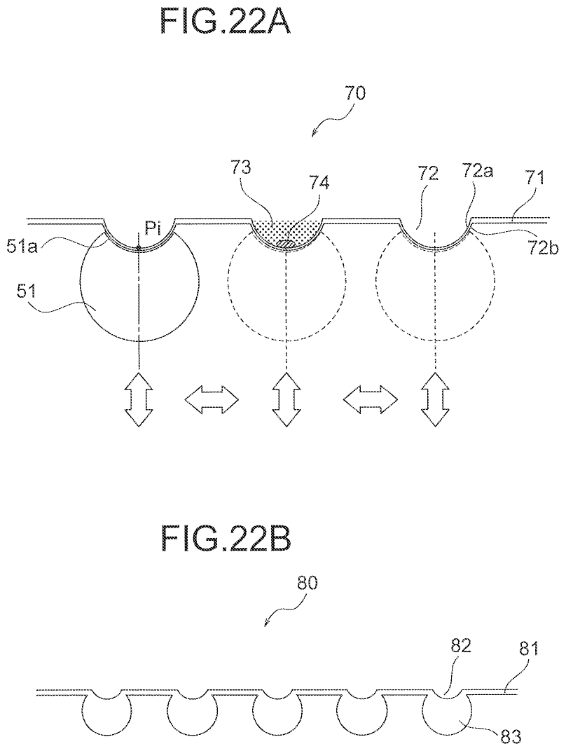

FIG. 22 and FIG. 22B are diagrams illustrating the holding member. FIG. 22A is a diagram illustrating a first example of the holding member. FIG. 22B is a diagram illustrating a second example of the holding member.

The holding member of the first example is described. A holding member 70 includes a plate-like portion 71 and concave portions 72. The plate-like portion 71 is formed of a material that allows transmission of light. In each concave portion 72, a specimen 74 is held together with liquid 73.

In the microscope 60, the microscope objective lens 50 described above is used as the microscope objective lens 61. Thus, the lens 51 is positioned under the concave portion 72. Both of a front surface 72a and a back surface 72b of the concave portion 72 are spherical surfaces. A radius of curvature of the back surface 72b is identical to a radius of curvature of the reduction-side surface 51a. Thus, it is possible to bring the lens 51 in proximity to the back surface 72b.

When the specimen 74 is a thick specimen, one surface is positioned on the back surface 72b side and the other surface is positioned on the liquid 73 side. In the microscope objective lens 50, it is possible to make a light ray going away from the lens 51 to contribute to image formation. The light ray going away from the lens 51 can be considered as light from the other surface. Thus, in the microscope 60, it is possible to form an optical image of the other surface.

In the holding member 70, a specimen is held in each of the concave portions 72 two-dimensionally arranged. Thus, in observation using the holding member 70, it is necessary to move the microscope objective lens 50 and the holding member 70 relative to each other in a direction orthogonal to the optical axis.

At a time of observation of the concave portion 72, the reduction-side surface 51a is in proximity to the back surface 72b. Therefore, it is not possible to move the microscope objective lens 50 and the holding member 70 relative to each other in the direction orthogonal to the optical axis in the proximate state.

In observation using the microscope objective lens 50, when the adjacent concave portion 72 is to be observed, the microscope objective lens 50 and the holding member 70 are moved relative to each other in the optical axis direction. With relative movement in the optical axis direction, it is possible to move the microscope objective lens 50 away from the holding member 70. Thus, it is possible to move the microscope objective lens 50 to below the concave portion 72 to be observed next.

In the concave portion 72, the specimen 74 is held together with the liquid 73. Therefore, there is a possibility that the specimen 74 moves if the holding member 70 is moved. Furthermore, there is a possibility that the liquid 73 spills out of the concave portion 72. Thus, it is preferable that the holding member 70 be fixed.

FIG. 22A illustrates a state in which the lens 51 is moved in a state in which the holding member 70 is fixed. As illustrated in FIG. 22A, the lens 51 moves in the optical axis direction and the direction orthogonal to the optical axis.

In the microscope 60, the microscope objective lens 61 is fixed to a revolver. Thus, the microscope 60 may be provided with a mechanism configured to move the revolver.

When the concave portion 72 need not be filled with liquid, it is possible to move the holding member 70. In this case, the stage 62 may be provided with a movement mechanism.

The holding member of the second example is described. A holding member 80 includes a plate-like portion 81, concave portions 82, and spherical portions 83. The plate-like portion 81 and the spherical portions 83 are formed of a material that allows transmission of light. Each spherical portion 83 has the same shape as the lens 51. Thus, the holding member 80 has a lens action.

The optical apparatus of the present embodiment includes the optical system described above and a display device disposed at the enlargement-side conjugate point.

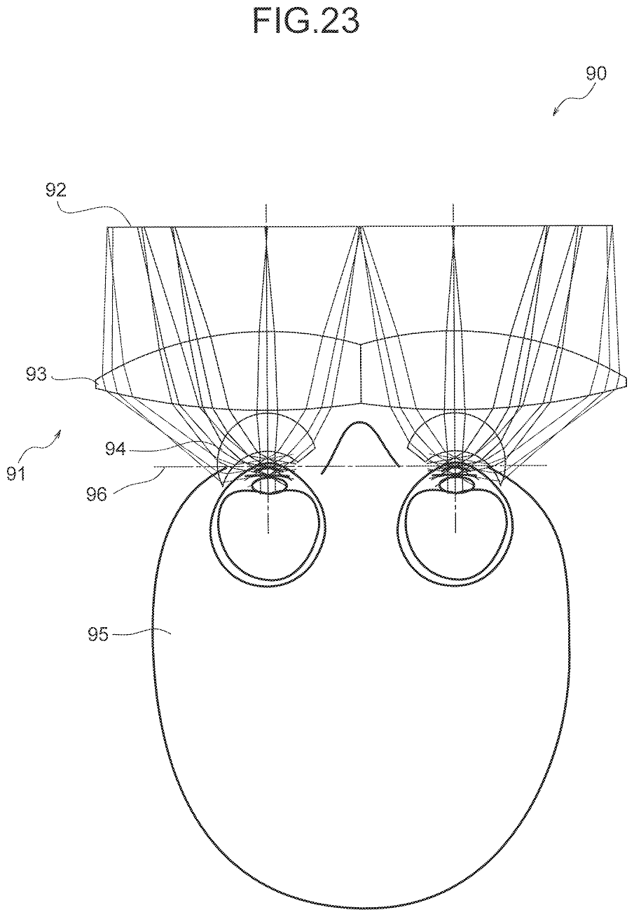

FIG. 23 is a diagram illustrating a fourth example of the optical system of the present embodiment. The optical apparatus of the fourth example is VR goggles. VR goggles 90 include an eyepiece optical system 91 and a display element 92. The eyepiece optical system 91 includes a lens 93 and lens 94. The optical system of Example 6 is used for the eyepiece optical system 91. A straight line 96 is a straight line passing through the reduction-side conjugate point.

In the lens 94, a reduction-side surface is a concave curved surface on the reduction side, and an enlargement-side surface is a convex curved surface on the enlargement side. The enlargement-side surface is a curved surface extending beyond a hemisphere. Thus, the lens 94 is a super-hemispherical meniscus lens. In the eyepiece optical system 91, one super-hemispherical meniscus lens is disposed on the reduction side.

In the lens 94, an intersection of the reduction-side surface and the optical axis of the eyepiece optical system 91 is positioned closer to the enlargement side than the reduction-side conjugate point. An reduction-side intersection is positioned closer to the reduction side than the reduction-side conjugate point. Thus, it is possible to make a light ray going away from the lens 51 to contribute to image formation.

In the VR goggles 90, the display element 92 is positioned on the enlargement side. Thus, light reaches the reduction-side conjugate point from a position closer to the reduction side than the reduction-side conjugate point, in the same manner as in the image pickup apparatus 1. In the VR goggles 90, it is possible to make such a light ray to contribute to image formation.

The display element 92 is disposed at the enlargement-side conjugate point of the eyepiece optical system 91. When the VR goggles 90 are mounted on a user's head 95, the pupils of the user's eyes are positioned on the straight line 96. Then, the user can view an image appearing on the display element 92.

In the eyepiece optical system 91, two lenses are used. Therefore, it is difficult to sufficiently correct chromatic aberration and distortion. In this case, it is preferable to process an image appearing on the display element 92. The processed image is processed such that the user is unable to recognize chromatic aberration and distortion when the user views the image. By viewing the processed image, the user can view a sharp image with no distortion.

According to the present disclosure, it is possible to provide an optical system that is bright and has a high resolving power, and an optical apparatus including the same.

As described above, the embodiments according to the present disclosure are suitable for an optical system that is bright and has a high resolving power, and an optical apparatus including the same.

What is claimed is:

1. An optical system in which an enlargement-side conjugate point positioned on an enlargement side and a reduction-side conjugate point positioned on a reduction side are conjugate,
a distance from the optical system to the enlargement-side conjugate point being longer than a distance from the optical system to the reduction-side conjugate point,
the optical system comprising a super-hemispherical meniscus lens, wherein
the super-hemispherical meniscus lens has a reduction-side surface positioned on the reduction side and an enlargement-side surface positioned on the enlargement side,
the reduction-side surface is a concave curved surface on the reduction side,
the enlargement-side surface is a convex curved surface on the enlargement side, having a positive refractive power,
the curved surface of the enlargement-side surface is a curved surface extending beyond a hemisphere,
an intersection of the reduction-side surface and an optical axis of the optical system is positioned closer to the enlargement side than the reduction-side conjugate point, and
a reduction-side intersection is positioned closer to the reduction side than the reduction-side conjugate point,
where
the reduction-side intersection is an intersection of a reduction-side virtual plane and the optical axis of the optical system,
the reduction-side virtual plane is a plane including an intersection of an outside ray and the reduction-side surface and being orthogonal to the optical axis of the optical system,
the outside ray is a light ray passing through a position farthest from a center of the reduction-side surface, among light rays contributing to image formation,
a predetermined lens is the super-hemispherical meniscus lens positioned closest to the reduction-side conjugate point, and
the following Conditional Expression (3) is satisfied:
0<R1/F<0.6 (3)
where
R1 is a radius of curvature of the reduction-side surface of the predetermined lens, and
F is a focal length of the optical system.

2. An optical system in which an enlargement-side conjugate point positioned on an enlargement side and a reduction-side conjugate point positioned on a reduction side are conjugate,
a distance from the optical system to the enlargement-side conjugate point being longer than a distance from the optical system to the reduction-side conjugate point,
the optical system comprising a super-hemispherical meniscus lens, wherein
the super-hemispherical meniscus lens has a reduction-side surface positioned on the reduction side and an enlargement-side surface positioned on the enlargement side,
the reduction-side surface is a concave curved surface on the reduction side,
the enlargement-side surface is a convex curved surface on the enlargement side, having a positive refractive power,
the curved surface of the enlargement-side surface is a curved surface extending beyond a hemisphere,
an intersection of the reduction-side surface and an optical axis of the optical system is positioned closer to the enlargement side than the reduction-side conjugate point, and
a reduction-side intersection is positioned closer to the reduction side than the reduction-side conjugate point,
where
the reduction-side intersection is an intersection of a reduction-side virtual plane and the optical axis of the optical system,
the reduction-side virtual plane is a plane including an intersection of an outside ray and the reduction-side surface and being orthogonal to the optical axis of the optical system,
the outside ray is a light ray passing through a position farthest from a center of the reduction-side surface, among light rays contributing to image formation,
a predetermined lens is the super-hemispherical meniscus lens positioned closest to the reduction-side conjugate point, and
the following Conditional Expression (4) is satisfied:
0<R2/F<0.6 (4)
where
R2 is a radius of curvature of the enlargement-side surface of the predetermined lens, and
F is a focal length of the optical system.

3. The optical system according to claim 1, wherein
an enlargement-side intersection is positioned closer to the reduction side than the reduction-side conjugate point is,
where
the enlargement-side intersection is an intersection of an enlargement-side virtual plane and the optical axis of the optical system,
the enlargement-side virtual plane is a plane including an intersection of a predetermined outside ray and the enlargement-side surface and being orthogonal to the optical axis of the optical system, and
the predetermined outside ray is a light ray after the outside ray passes through the reduction-side surface.

4. The optical system according to claim 1, wherein
the following Conditional Expression (1) is satisfied:
0 (mm)<D1sag (1)
where
D1sag is a distance between the reduction-side conjugate point and the reduction-side intersection.

5. The optical system according to claim 3, wherein
the following Conditional Expression (2) is satisfied:
0 (mm)<D2sag (2)
where
D2sag is a distance between the reduction-side conjugate point and the enlargement-side intersection.

6. The optical system according to claim 3, further comprising at least one super-hemispherical meniscus lens that satisfies both of the following Conditional Expression (1) and Conditional Expression (2):
0 (mm)<D1sag (1)
0 (mm)<D2sag (2)
where
D1sag is a distance between the reduction-side conjugate point and the reduction-side intersection, and
D2sag is a distance between the reduction-side conjugate point and the enlargement-side intersection.

7. An optical apparatus comprising:
the optical system according to claim 1; and
an image pickup element disposed at the reduction-side conjugate point.

8. An optical apparatus comprising:
the optical system according to claim 1; and
a light source disposed at the reduction-side conjugate point.

9. An optical apparatus comprising:
the optical system according to claim 1; and
a holding mechanism configured to position an object at the reduction-side conjugate point.

10. An optical apparatus comprising:
the optical system according to claim 1; and
a display device disposed at the enlargement-side conjugate point.

11. An optical system in which an enlargement-side conjugate point positioned on an enlargement side and a reduction-side conjugate point positioned on a reduction side are conjugate,
a distance from the optical system to the enlargement-side conjugate point being longer than a distance from the optical system to the reduction-side conjugate point,
the optical system comprising a super-hemispherical meniscus lens, wherein
the super-hemispherical meniscus lens has a reduction-side surface positioned on the reduction side and an enlargement-side surface positioned on the enlargement side,
the reduction-side surface is a concave curved surface on the reduction side,
the enlargement-side surface is a convex curved surface on the enlargement side, having a positive refractive power,
the curved surface of the enlargement-side surface is a curved surface extending beyond a hemisphere, and
the reduction-side conjugate point is positioned inside a spherical segment of the reduction-side surface.
